(19) United States
(12) Patent Application Publication
(10) Pub. No.: US 2010/0057534 A1
(43) Pub. Date: Mar. 4, 2010

(54) ADVERTISING-BUYING OPTIMIZATION METHOD, SYSTEM, AND APPARATUS

(75) Inventor: Amy Rachel GERSHKOFF, Washington, DC (US)

Correspondence Address: BUCHANAN, INGERSOLL & ROONEY PC, POST OFFICE BOX 1404, ALEXANDRIA, VA, 22313-1404, US

(73) Assignee: SMART CHANNEL, L.L.C., Washington, DC (US)

(21) Appl. No.: 12/239,327

(22) Filed: Sep. 26, 2008

Related U.S. Application Data
(60) Provisional application No. 61/092,149, filed on Aug. 27, 2008.

(51) Int. Cl. G06F 17/30; G06F 9/44; G06Q 30/00; G06Q 90/00

(52) U.S. Cl. 705/10; 705/7; 705/14.66

(57) ABSTRACT

A method, system, and apparatus for optimizing advertising buying is disclosed. The method comprises: obtaining data on media consumption habits of a defined set of individuals; optionally matching the data on media consumption habits to a database containing information regarding the individuals; optionally aggregating the data on media consumption habits by each individual; optionally recoding the data on media consumption habits using predetermined criteria to obtain recoded data; optionally removing the data on media consumption habits to obtain the recoded data only; creating clusters based on media consumption habits of the individuals; optionally creating profiles of each cluster to obtain defined clusters; optionally identifying the defined clusters; creating media consumption profiles for each defined cluster; optionally determining non-targeted individuals reached by each potential buy for each defined cluster; optionally attaching costs to each potential buy for each defined cluster; defining buys based on maximum coverage of the targeted individuals, optionally minimum coverage of non-targeted individuals, and optionally the lowest cost; and obtaining an optimized rank-ordered list of buys for one or more one or more media buyers.

### CROSS-REFERENCE TO RELATED APPLICATIONS

This application claims priority from U.S. Provisional Patent Application No. 61/092,149, entitled Advertising-Buying Optimization System, Apparatus, and Method, filed Aug. 27, 2008, which is incorporated herein in its entirety by this reference thereto.

### BACKGROUND

Television advertising is purchased in much the same way today as it was in the late 1950s. Media buyers seeking to reach a particular demographic group through television advertising (e.g., wealthy women over 50) acquire data on television viewing habits from a company such as Nielsen. This data gives a description of the types of demographic groups that watch each program. So media buyers seeking to reach a particular demographic group (e.g., wealthy women over 50) would look at the list of programs and find all the programs that have significant viewership among that target demographic group. In other words, the current process for media buying typically involves (1) determining the target demographic, (2) figuring out programs watched by that demographic, and (3) buying those programs. This method has several disadvantages that make it significantly less efficient.

First, media buyers are paying for impressions with people who are clearly outside of their target audience. Many advertising buys that reach a wide audience may reach a significant proportion of the media buyer's targets but also a significant proportion of non-targets. A primetime broadcast television advertising buy is one such example: such an advertising buy can reach some members of the media buyer's target, but it can also reach significant numbers of non-targets at tremendous cost.

Second, the method does not provide media buyers ways to find other (e.g., cheaper) programs watched by the same audience. The current method for correlating demographics with (i) television programs watched and (ii) whether or not the individual is a “target” for the media buyer makes it difficult to connect television programs to the individuals. For example, program A might be watched by wealthy women over 50, and program B might be watched by wealthy women over 50, but the in the traditional method of purchasing advertising described above, it cannot be ascertained if these are the same wealthy women over 50. This becomes an important piece of information if program A costs, for example, about $400 per Gross Rating Point to buy advertising on and program B costs, for example, about $40 per Gross Rating Point to buy advertising on, it may be that buying program B gives the media buyer a cheaper way to reach the same audience, or merely a way to reach an entirely different group of women over 50 who do not watch program A. The traditional method of purchasing advertising described above provides no way of making such a determination.

Third, a media buyer cannot precisely target certain groups using available demographic information. In politics, for instance, if polling indicates that voters most receptive to a candidate's message are wealthy women over 50, that merely means that wealthy women over 50 are more likely than the average voter to be good advertising targets, but it does not necessarily mean that all wealthy women over 50 would be good advertising targets. In particular, a media buyer in the aforementioned situation might wish to screen out Republican wealthy women over 50 (if the candidate is a Democrat), or perhaps Republican and Democratic wealthy women over 50 (if the candidate is seeking to reach Independents).

The aforementioned problem frequently arises in commercial advertising as well. Wealthy women over 50 may be more likely than the average individual to purchase a cruise vacation, but that does not mean all wealthy women over 50 are good targets for advertising by a cruise company. In particular, the cruise company in the foregoing example may wish to be able to screen out wealthy women over 50 who have not taken a trip in the last year and/or have no frequent flier accounts. While it may be difficult for a media buyer to entirely avoid advertising to women over 50 who have not taken a trip in the last year and/or have no frequent flier accounts, if the media buyer could ensure that a minimum number of women from this group may be targeted, the media buyer would be more cost effective.

A fundamental problem with the above-described traditional advertising method is that media buyers are seeking a goal behavior (e.g., purchasing their product, voting for their candidate, etc.) and are relying upon demographic information about the types of people who engage in the goal behavior to predict another behavior (e.g., what television programs these people watch).

### SUMMARY

Accordingly, described in this application is a method, system, and apparatus which allows a media buyer to use a behavior (e.g., what television programs people watch) to predict a goal behavior (e.g., what product they will purchase, for which candidate they will vote for, etc.), without requiring demographic information to predict either one. This method, system, and apparatus can be used in one or more advertising media, such as television and radio. Demographics-related data is not the necessarily the best predictor of goal behaviors, such as the ones described above.

The method, system, and apparatus described herein relate to optimizing advertising-buying. The method allows a media buyer, for example, to determine what bundles of television programs target groups of individuals are watching. In other words, the method described herein can provide information to the buyer such as people who watch program X also tend to watch programs Y and Z.

The reason that this is relevant is that if program X costs about $400 per Gross Rating Point, program Y costs about $40 per Gross Rating Point, and program Z costs about $4 per Gross Rating Point, it can be determined when a cheaper program should be selected to reach the same audience. Prior to the presently described system, it could only be determined that similar demographics watched all three programs, but it was not known if the same groups of individuals actually tended to watch all three programs or whether it was the case that entirely separate groups of individuals who happen to share a common demographic trait were each watching different programs.

This advertising-buying optimization method, then, gives media buyers a potentially cheaper way to reach the target groups of individuals, as well as a way to ensure that the audience they are reaching contains more of their true intended targets and fewer numbers of their non-targets.

The resulting gains in efficiency can be large regardless of the media budget, and can quickly increase with media budget size. A media buyer using the presently described method (i.e., advertising-buying optimization method) can save hundreds of thousands of dollars and maybe even millions of dollars compared with using traditional methods for advertising-buying. This cost savings comes from finding cheaper ways to reach the same target groups of individuals, as well as by finding advertising buys that include a higher concentration of the media buyer's target groups of individuals than buying advertising with traditional methods. For example, media buyers with media budgets of more than about $10 million could potentially see savings well over about $1 million. Further, it can be estimated that media buyers with budgets in excess of about $100 million could see savings in the tens of millions of dollars by using the presently described method, system, and apparatus.

The presently described method, system, and apparatus can be used to purchase political advertising, commercial advertising, etc. Further, this method, system, and apparatus can be used to purchase advertising on television, radio, and other media channels (e.g., billboards, websites, etc). According to this method, system, and apparatus, a media buyer can optimize media buying within each media channel and/or various media channels for communicating with the target groups of individuals in the most effective manner.

In an embodiment, the advertising-buying optimization method is carried out using SmartBuy™ software provided by Smart Channel, L.L.C. The SmartBuy™ software is described in detail in the Detailed Description. In other embodiments, the advertising-buying optimization method can be carried out using other commercially available clustering programs such as k-means clustering by SPSS®, other SPSS® clustering algorithms, other commercially available clustering programs such as SAS® or STATA®.

It can be preferable to use the SmartBuy™ software in the advertising-buying optimization method described herein because this software offers the media buyer cluster solutions specifically for buying advertising because the software was designed specifically for buying advertising, as opposed to commercially available clustering software that was designed with other commercial or general uses in mind. In particular, the SmartBuy™ software was specifically designed to produce clusters that are distinct (i.e., the cases within each cluster has strong similarity to one another but the clusters are far apart in n-dimensional space from the next nearest group of clusters). Further, the SmartBuy™ software helps to ensure that the clusters are distinct and effective by not forcing each case into a cluster.

The SmartBuy™ software also allows the media buyer flexibility in the choice of distance, function, sensitivity levels, minimum cluster size, etc., thereby allowing the media buyer to optimize the cluster methodology for the particular data and media buying project at hand.

According to an embodiment, a method, system, and apparatus for optimizing advertising buying for one or more media buyers having a budget for each channel in a single or a multi-channel campaign are disclosed. As shown in FIG. 1, the method comprises: creating clusters based on media consumption habits of individuals (step 110); creating media consumption profiles for each defined cluster (step 112); optionally attaching costs to each potential buy for each defined cluster (step 114); and selecting one or more of the buys for the one or more media buyers (step 116). A computer readable tangible medium bearing executable computer code that causes a programmable device to carry out the method of this embodiment is also disclosed.

According to another embodiment, a method, system, and apparatus for optimizing advertising buying for one or media buyers having a budget for a multi-channel campaign but not a specified division of the budget for various channels in the campaign is disclosed. As shown in FIG. 2, the method comprises: creating clusters based on media consumption habits of individuals (step 210); creating media consumption profiles for each defined cluster (step 212); optionally attaching costs to each potential buy for each defined cluster (step 214); and selecting one or more of the buys for the one or more media buyers (step 216). A computer readable tangible medium bearing executable computer code that causes a programmable device to carry out the method of this embodiment is also disclosed.

According to an embodiment, a method, system, and apparatus for creating defined clusters for one or more media buyers seeking to buy advertising is disclosed. As shown in FIG. 3, the method comprises: obtaining data on media consumption habits of a defined set of individuals (step 310); optionally matching the data on media consumption habits to a database containing information regarding the individuals (step 312); optionally recoding the data on media consumption using predetermined criteria to obtain recoded data (step 314); optionally removing the data on media consumption to obtain the recoded data only (step 316); creating clusters based on media consumption habits of the individuals (step 318). A computer readable tangible medium bearing executable computer code that causes a programmable device to carry out the method of this embodiment is also disclosed.

According to another embodiment, a method, system, and apparatus for obtaining a cluster solution is disclosed. As shown in FIG. 4, the method comprises: (A) loading database A2 into a computer program (step 410), wherein database A2 is obtained by: obtaining data on media consumption habits of a defined set of individuals; matching the data on media consumption habits to a database containing information regarding the individuals; recoding the data on media consumption using predetermined criteria to obtain recoded data; optionally removing the data on media consumption to obtain the recoded data only identified as database A2; (B) selecting either manually or automatically the (i) optimal distance function, (ii) the clustering approach, (iii) the optimal agglomeration method, (iv) the minimum cluster size, (v) the method for pruning smaller clusters, and (vi) the sensitivity level (step 412); (C) running the clustering program based on the selections in (B)(i)-(B)(vi) to obtain a diagnostic output of clusters and outliers (step 414); (D) examining the diagnostic output of clusters (step 416); (E) repeating steps (B)-(D) until a cluster solution is obtained meeting the pre-determined criteria (step 418); and (F) optionally validating the cluster solution (step 420). A computer readable tangible medium bearing executable computer code that causes a programmable device to carry out the method of this embodiment is also disclosed.

According an embodiment, a computer readable medium storing a computer program, the computer program when executed in a computer executing a method is disclosed. As shown in FIG. 5, the method comprises: (A) selecting either manually or automatically the (i) optimal distance function, (ii) the clustering approach; (iii) the optimal agglomeration method, (iv) the minimum cluster size, (v) the method for pruning smaller clusters, and (vi) the sensitivity level; (step 510); (B) running the clustering program based on the selections in (A)(i)-(A)(vi) to obtain a diagnostic output of clusters and outliers (step 512); (C) examining the diagnostic output of clusters and outliers (step 514); (D) repeating steps (A)-(C) until a cluster solution is obtained meeting the pre-determined criteria (step 516); and (E) optionally validating the cluster solution (step 518). A computer readable tangible medium bearing executable computer code that causes a programmable device to carry out the method of this embodiment is also disclosed.

According to another embodiment, a method, system, and apparatus for optimizing advertising buying are disclosed. As shown in FIG. 6 the method comprises: (i) obtaining data on media consumption habits of a defined set of individuals (step 610); (ii) optionally matching the data on media consumption habits to a database containing information regarding the individuals (step 612); (iii) optionally aggregating the data on media consumption habits by each individual (step 614); (iv) optionally recoding the data on media consumption habits using predetermined criteria to obtain recoded data (step 616); (v) optionally removing the data on media consumption habits to obtain the recoded data only (step 618); (vi) creating clusters based on media consumption habits of the individuals (step 620); (vii) optionally creating profiles of each cluster to obtain defined clusters (step 622); (viii) optionally identifying the defined clusters (step 624); (ix) creating media consumption profiles for each defined cluster (step 626); (x) optionally determining non-targeted individuals reached by each potential buy for each defined cluster (step 628); (xi) optionally attaching costs to each potential buy for each defined cluster (step 630); (xii) defining buys based on maximum coverage of the targeted individuals, optionally minimum coverage of non-targeted individuals, and optionally the lowest cost (step 632); and (xiii) obtaining an optimized rank-ordered list of buys for one or more one or more media buyers (step 634). A computer readable tangible medium bearing executable computer code that causes a programmable device to carry out the method of this embodiment is also disclosed.

According to an embodiment, a method, system, and apparatus for creating clusters based on media consumption habits of individuals is disclosed. As shown in FIG. 7, the method comprises: obtaining data on media consumption habits of the individuals (step 710); optionally aggregating the data on media consumption habits by each individual (step 712); optionally recoding the data on media consumption habits using predetermined criteria to obtain recoded data (step 714); and creating clusters based on media consumption habits of the individuals (step 716). A computer readable tangible medium bearing executable computer code that causes a programmable device to carry out the method of this embodiment is also disclosed.

According to an embodiment, a method, system, and apparatus for creating clusters based on media consumption habits of individuals is disclosed. As shown in FIG. 8, the method comprises: obtaining data on media consumption habits of the individuals (step 810); optionally matching the data on media consumption habits to a database containing information regarding the individuals (step 812); optionally aggregating the data on media consumption habits by each individual (step 814); optionally recoding the data on media consumption habits using predetermined criteria to obtain recoded data (step 816); and creating clusters based on media consumption habits of the individuals (step 818). A computer readable tangible medium bearing executable computer code that causes a programmable device to carry out the method of this embodiment is also disclosed.

According to another embodiment, a method, system, and apparatus for optimizing advertising buying are disclosed. As shown in FIG. 9 the method comprises: (i) obtaining data on media consumption habits of a defined set of individuals (step 910); (ii) matching the data on media consumption habits to a database containing information regarding the individuals (step 912); (iii) aggregating the data on media consumption habits by each individual (step 914); (iv) recoding the data on media consumption habits using predetermined criteria to obtain recoded data (step 916); (v) removing the data on media consumption habits to obtain the recoded data only (step 918); (vi) creating clusters based on media consumption habits of the individuals (step 920); (vii) creating profiles of each cluster to obtain defined clusters (step 922); (viii) identifying the defined clusters (step 924); (ix) creating media consumption profiles for each defined cluster (step 926); (x) determining non-targeted individuals reached by each potential buy for each defined cluster (step 928); (xi) attaching costs to each potential buy for each defined cluster (step 930); (xii) defining buys based on maximum coverage of the targeted individuals, minimum coverage of non-targeted individuals, and the lowest cost (step 932); and (xiii) obtaining an optimized rank-ordered list of buys for one or more one or more media buyers (step 934). A computer readable tangible medium bearing executable computer code that causes a programmable device to carry out the method of this embodiment is also disclosed.

FIG. 10 shows a schematic 1000 of a system for optimizing advertising buying according to embodiments described herein. In this system, the optimization can be carried out using a network 1000 and/or a computer workstation 1014. In using the network 1000 and/or the computer workstation 1014, media consumption habits of a defined set of individuals 1020 can be (i) loaded onto a server 1022 and then inputted into the computer workstation 1014 or (ii) directly inputted into the computer workstation 1014. If, the computer workstation 1014 is used to conduct the optimization process, then a computer readable medium 1016, such as a CD-ROM, storing a computer program as described hereinbelow, can be inserted into the computer workstation 1014 and the computer workstation 1014 outputs a list of optimized advertising buys 1018 either on the same computer workstation 1014 or another computer workstation 1024 communicatively connected with the computer workstation 1014. If, the network 1010 is used to conduct the optimization process, then the network 1010 conducts the optimization process, which is described hereinbelow in detail, and the network 1010 outputs a list of optimized advertising buys 1018 on computer workstation 1014 and/or another computer workstation 1024.

### BRIEF DESCRIPTION OF THE DRAWINGS

FIG. 1 is a flowchart showing a method for optimizing advertising buying for one or more media buyers having a budget for each channel in a single or a multi-channel campaign according to one embodiment.

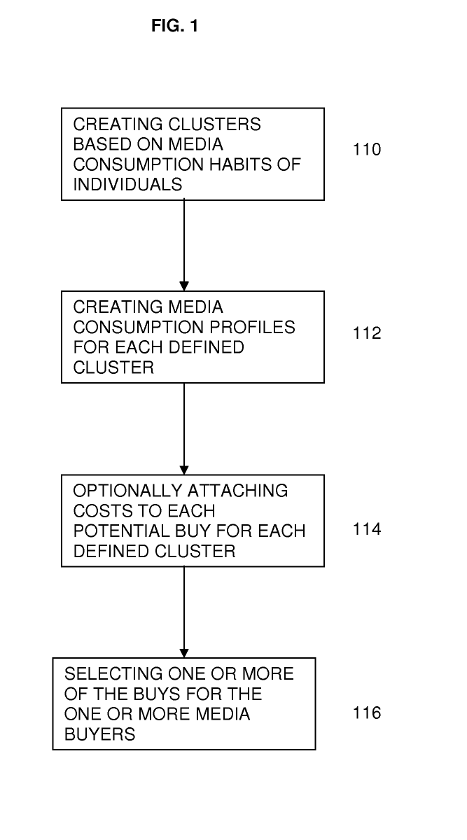

FIG. 2 is a flowchart showing a method for optimizing advertising buying for one or media buyers having a budget for a multi-channel campaign but not a specified division of the budget for various channels in the campaign according to one embodiment.

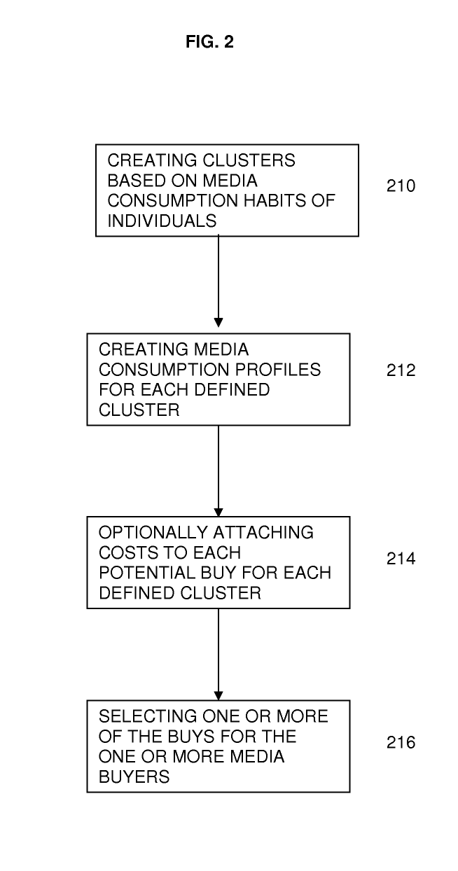

FIG. 3 is a flowchart showing a method for creating defined clusters for one or more media buyers seeking to buy advertising according to one embodiment.

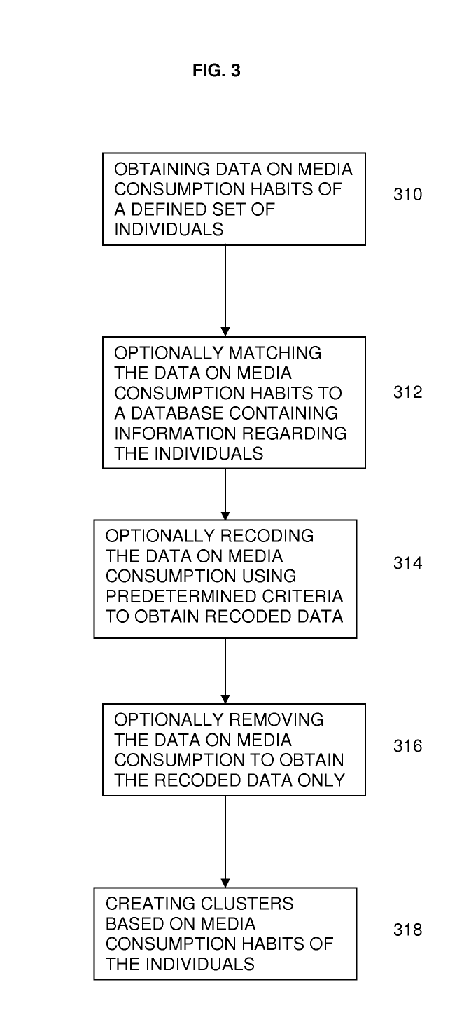

FIG. 4 is a flowchart showing a method for obtaining a cluster solution according to another embodiment.

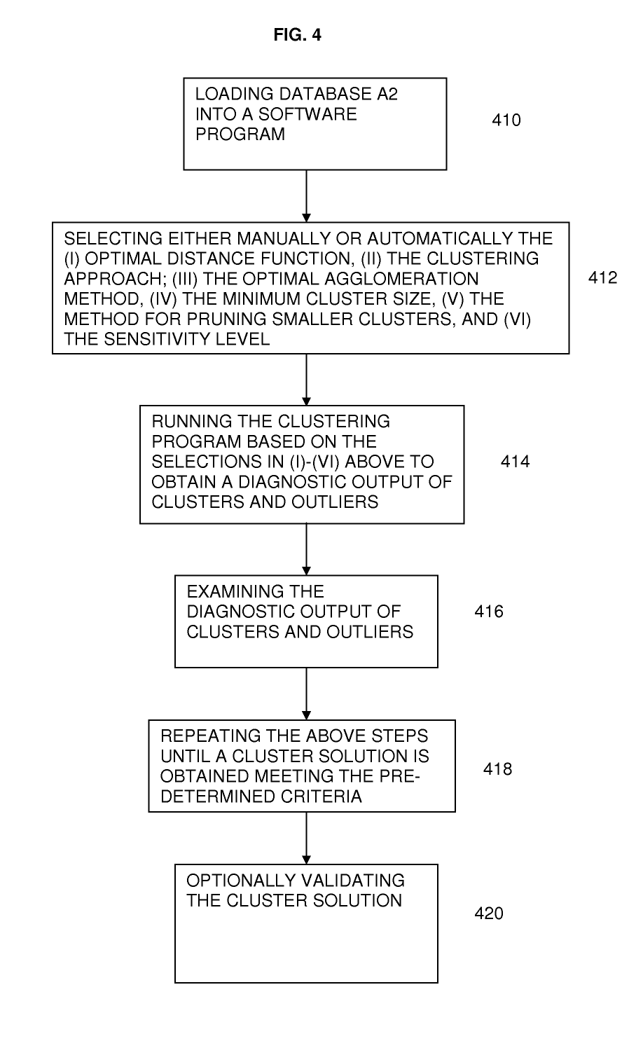

FIG. 5 is a flowchart showing a method carried out by a computer readable program according to one embodiment.

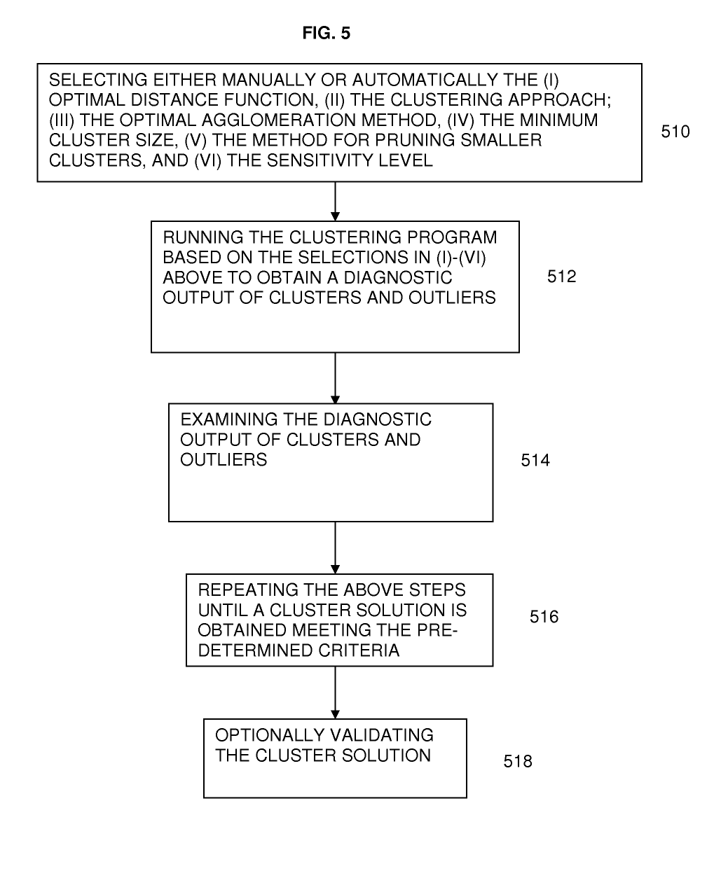

FIG. 6 is a flowchart showing a method for optimizing advertising buying according to an embodiment.

FIG. 7 is a flowchart showing a method for creating clusters based on media consumption habits of individuals according to another embodiment.

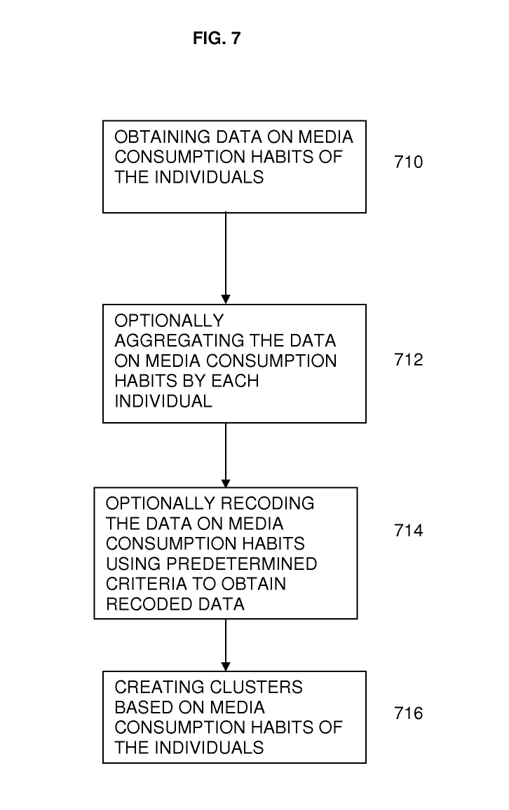

FIG. 8 is a flowchart showing a method for creating clusters based on media consumption habits of individuals according to another embodiment.

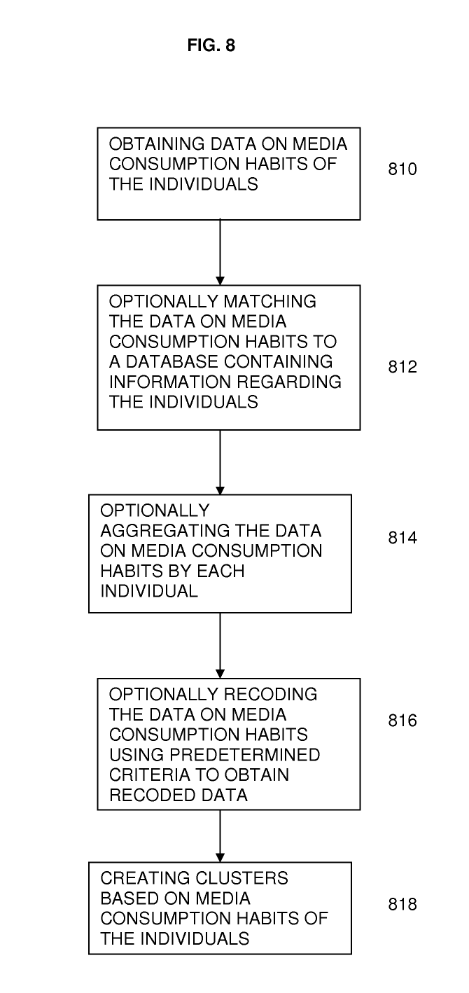

FIG. 9 is a flowchart showing a method for optimizing advertising buying according to another embodiment.

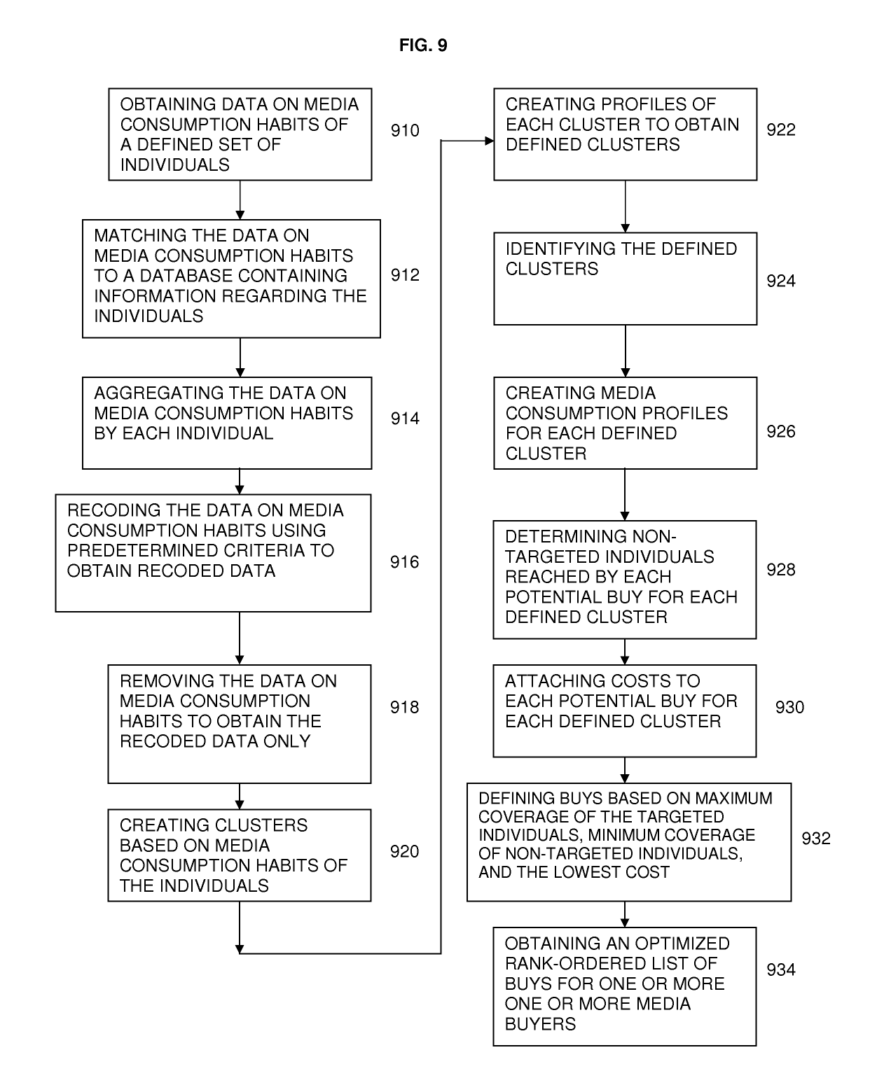

FIG. 10 is a schematic showing a system for optimizing advertising buying according embodiments described herein.

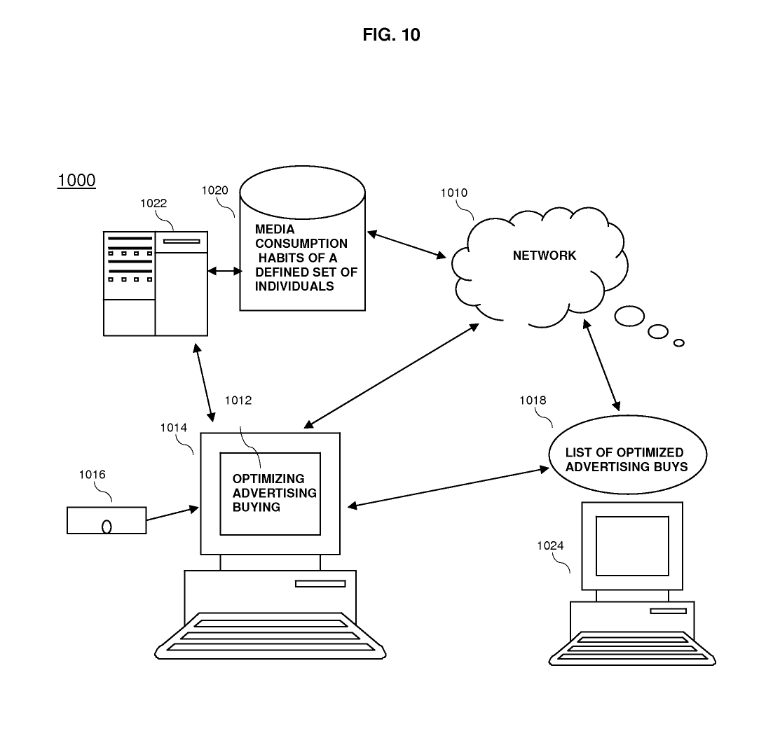

### DETAILED DESCRIPTION

### Definitions

The terms “about” or “approximately” when associated with a numeric value refers to that numeric value plus or minus 10%, preferably plus or minus 5%, more preferably plus or minus 2%, most preferably plus or minus 1%.

“Groups of individuals”, as used herein, refer to the natural persons who are being targeted by media buyers to achieve a goal behavior such as purchasing the media buyer's product(s), voting for the media buyer's candidate, etc.

“Media buyer”, as used herein, refers to individuals who use the methods described herein to target groups of individuals to achieve goal behavior(s), such as those discussed above. The term “media buyer” can be used interchangeably with advertiser, media planner, media consultant, advertising buyer, and media buyer. One skilled in the art will appreciate that the media buyer can request one or more individuals to carry out the methods described herein to target groups of individuals to achieve goal behavior(s). The term “media buyer” can encompass one or more media buyers in the following description.

“Bundles”, as used herein, refer to groups of media programs (e.g., television programs, radio shows, etc.) watched by and/or listened to by target groups of individuals.

“Gross Rating Point”, as used herein, refers to the reach of the media multiplied by the frequency of exposure to that media. For example, with television, that would refer to the percentage of people who were exposed to a given television advertisement multiplied by the average number of times those people were exposed to the given television advertisement.

“Personal or household attributes”, as used herein, include demographic information, information about the neighborhood in which the individual lives, home ownership, employment status, location, party registration, microtargeting scores or models, models of other attributes or behaviors, vote history, purchase history, government licenses such as those issued for certain recreations or occupations, geographic, consumer, attitudinal, behavioral data, other data of public record, or any data that can be purchased, traded, or otherwise acquired. The foregoing data can be acquired at any level, such as individual, household, zip code, county, etc.

“Case”, as used herein, refers to natural persons.

“Individual”, as used herein, refers to natural persons.

“Buys”, as used herein, refers to an advertising purchase or potential purchase made based upon the methods described herein. For example, for television, that would include the network, day of the week, and time interval during which the advertisement will run.

“Media”, as used herein, refers to television, radio, billboards, street furniture components, printed flyers and rack cards, cinema advertising, web banners, mobile telephone screens, shopping carts, web popups, skywriting, bus stop benches, magazines, newspapers, town criers, sides of buses or airplanes, in-flight advertisements (e.g., on seatback tray tables, overhead storage bins, seat backs, window shades, tray tables, drink carts, etc.), taxicabs (e.g., doors, roof mounts, passenger screens, etc.), musical stage shows, subway platforms and trains, shopping cart handles, the opening section of streaming audio and video, posters, wall paintings, internet banner advertising, and the backs of event tickets and supermarket receipts. In preferred embodiments, the advertising “media” refers to television and radio. The term media can be used interchangeably with channel, as appropriate.

“Computer readable media”, as used herein, refers to means any tangible media that can be read by a computer, including but not limited to mechanical, optical, magnetic and electronic memory media, whether volatile or non-volatile.

“Day-part”, as used herein, refers to a time period during a 24-hour period during a specific day or days of the week during which advertising can be purchased as a unit. An example of a day-part is “prime time,” which typically encompasses the hours of 8 PM through 11 PM Monday through Friday on several broadcast television networks. Another example of day-part is “Tuesday prime time,” which typically encompasses Tuesdays between the hours of 8 PM through 11 PM on several broadcast television networks.

“Household”, as used herein, refers to a domestic unit consisting of members who typically reside together at a common address.

“Smallest unit of measure”, as used herein, refers to the specific level at which media consumption can be obtained by the media buyer in the data acquired for the analysis. For example, in some cases, “smallest unit of measure” may refer to individual-level data, meaning that within 2-person Household X, one can specifically distinguish between the programs watched by Person #1 and the programs watched by Person #2. For example, in other cases, the “smallest unit of measure” may refer to household-level data, meaning that within 2-person Household X, it is impossible to distinguish between the programs watched by Person #1 and the programs watched by Person #2. As another example, in other cases, “smallest unit of measure” may refer to zip code-level data, meaning that the media consumption data is reported by zip code, making it impossible to distinguish between programs watched by Household X and programs watched by Household Y within zip code Q. As another example, in some cases “smallest unit of measure” may refer to county-level data, meaning that the media consumption data is reported by county, making it impossible to distinguish between programs watched by Household X and programs watched by Household Y within county K. For example, smallest unit of measure data can include media consumption habits at a national level, state level, county level, neighborhood level, part of a neighborhood level, zip code level, precinct level, congressional district level, state house district level, state senate district level, regional level, individual level, household level, family level, media market level, cable system level, radio market level, and satellite television market level.

From hereonafter any references to “individuals” will encompass “households” and “smallest unit of measure” unless specified otherwise.

“Size of the media buyer's budget”, as used herein, refers to the dollar amount that the media buyer intends to spend on that particular advertising campaign. This can reflect the total amount across all media channels or it might reflect the amount spent on each specific media channel. In cases where the media buyer has a budget for the entire multi-channel campaign, “size of the media buyer's budget” will refer to the total dollar amount that the media buyer wishes to spend across all channels. In cases where the media buyer has a budget for one channel (e.g., television) and a different budget for another channel (e.g., radio), then media buyers can use the other detailed description above to optimize the advertising buy one channel at a time. It should be understood that a media buyer's budget can vary depending on the advertising campaign and it can be flexible depending on the advertising campaign.

“Advertising sales individuals and/or companies”, as used herein, refer to individuals or companies offering advertising space in one or more media channels.

### Generally

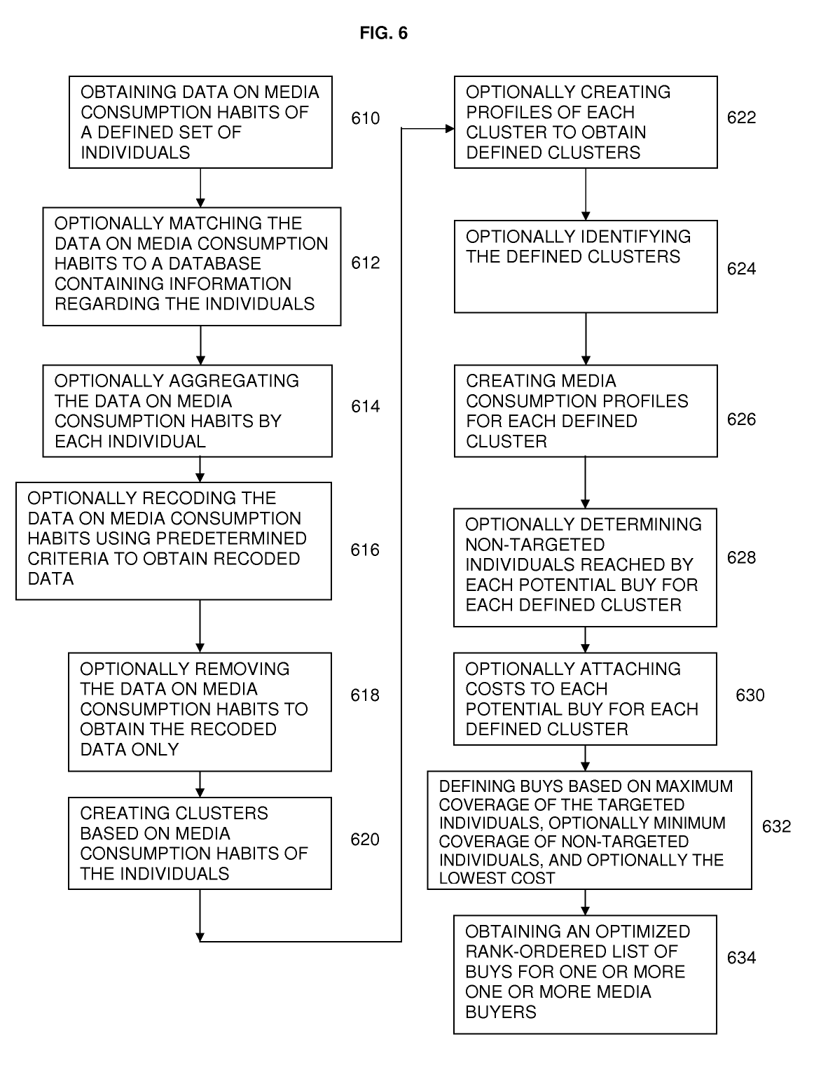

According to one embodiment, a method, system, and apparatus for optimizing advertising buying are disclosed. The method, as shown in FIG. 6, comprises: (i) obtaining data on media consumption habits of a defined set of individuals (step 610); (ii) optionally matching the data on media consumption habits to a database containing information regarding the individuals (step 612); (iii) optionally aggregating the data on media consumption habits by each individual (step 614); (iv) optionally recoding the data on media consumption habits using predetermined criteria to obtain recoded data (step 616); (v) optionally removing the data on media consumption habits to obtain the recoded data only (step 618); (vi) creating clusters based on media consumption habits of the individuals (step 620); (vii) optionally creating profiles of each cluster to obtain defined clusters (step 622); (viii) optionally identifying the defined clusters (step 624); (ix) creating media consumption profiles for each defined cluster (step 626); (x) optionally determining non-targeted individuals reached by each potential buy for each defined cluster (step 628); (xi) optionally attaching costs to each potential buy for each defined cluster (step 630); (xii) defining buys based on maximum coverage of the targeted individuals, optionally minimum coverage of non-targeted individuals, and optionally the lowest cost (step 632); and (xiii) obtaining an optimized rank-ordered list of buys for one or more one or more media buyers (step 634). The foregoing method steps are discussed below in detail.

Optimization Method for Advertising Buying is Provided in which a Media Buyer has a Budget for each Channel in a Multi-Channel Campaign

In the steps hereinbelow an optimization method for advertising buying is provided in which a media buyer has a budget for each channel in a multi-channel campaign. For example, a media buyer who has about $20 million to spend on a multi-channel campaign but has specified that for that campaign about $15 million may be devoted to television advertising and about $5 million to radio advertising would be classified as a media buyer having a budget for each channel in a multi-channel campaign. Media buyers who have a budget for each channel in a multi-channel campaign may likely wish to optimize the advertising buy one channel at a time.

While the steps below and the Examples that follow refer to television viewing and advertising, it should be understood that advertising on other media, as defined above, can be carried out using the same steps described hereinbelow.

### 1. Obtaining the Data on Media Consumption:

Obtain individual-level, household-level, or smallest unit of measure data on television viewing, which may include some or all of the following information: the network on which the television program aired, the day of the week on which it was aired, the date on which it was aired, the time of day on which the program aired, and the name of the actual television show that aired.

In this case, Nielsen data can be used. However, any data source that provides individual-level, household-level, or smallest unit of measure data on television viewing can be used. This data is hereinafter referred to as Database A.

Database A may be acquired in a wide variety of formats. All of these possible formats fall into two categories: (i) formats in which the data are already optimally recoded and summarized according to the method described hereinbelow, and (ii) formats in which the data are not already optimally recoded and summarized according to the method described hereinbelow.

The buyer can examine the data acquired in Database A to determine if it is of a format in which the data are already optimally recoded and summarized according to the method described hereinbelow, or whether the data can be recoded and summarized. In order to make this determination, it is necessary to discuss the optimal method for recoding and summarizing the data.

It has been found that the preferred method for recoding or summarizing the data depends on three factors: (1) the size of the media buyer's budget for a specific advertising campaign, (2) the level of detail about viewing habits available in the data from Database A, and (3) the number of cases in Database A. Table A below summarizes how these factors relate to determine the optimal method for recoding the data.

“Level of detail” in this case means the amount of information one has about what the individual, household, or smallest unit of measure watched. For instance, in some cases, Database A may provide only information about what television network the individual watched, while in other cases, Database A may provide information about not only the network but also the day and/or time the individual, household, or smallest unit of measure watched that network. In still other cases, Database A may provide information about the network, day, time, and program that was watched by an individual, household, or smallest unit of measure.

“Number of cases” refers to the number of individuals in Database A. In situations where Database A is household-level data, “number of cases” refers to the number of households in Database A. In situations where the data in Database A is provided at some level other than the individual or household-level, “number of cases” refers to the total number of units in the data, where each unit represents the smallest unit of measure in which viewing data is captured in Database A.

“Micro” level of summary in this case is defined as a detailed way of summarizing the data, based on the level of detail provided in Database A about viewing habits. For example, if the detailed information one has about viewing in Database A is simply the network that was watched and the day of the week on which it was watched, then summarizing the viewing data by network watched and day of the week that is the most “micro” level summary possible. If, however, the detailed information one has about viewing in Database A includes the network watched, the day of the week, the time of day, and the program that was watched, then that is the most micro-level summary possible involves summarizing the viewing data by network by day-part by program.

“Macro” level of summary in this case refers to the broadest possible way to summarize the data. One example might be to summarize the data by whether or not a network was watched at all at any point during the time that the data was collected for Database A.

TABLE A

| | NUMBER OF CASES IN DATABASE A | | |
|---|---|---|---|
| | Small (about 1,500 | Medium (about | Large (about 3,000+ |
| MEDIA BUDGET | or less) | 1,500-3,000 cases) | cases) |
| Small (about $1 | Most macro level of | Most macro level of | Most macro level of |
| million or less) | summary possible | summary possible | summary possible (e.g., |
| | (e.g., network without | (e.g., network without | network without regard |
| | regard to day-part, | regard to day-part, | to day-part, program, |
| | program, etc.), | program, etc.), | etc.), regardless of the |
| | regardless of the level | regardless of the level | level of detail in |
| | of detail in Database A | of detail in Database A | Database A |
| Medium (about $1-$8 | Most macro level of | Mid-level summary | Micro level summary |
| million) | summary possible | (e.g., network by day- | (e.g., network by day- |
| | (e.g., network without | part) if the level of | part by program, and in |
| | regard to day-part, | detail in Database A | some cases even by |
| | program, etc.), | is high enough; if the | cable system) if the level |
| | regardless of the level | level of detail in | of detail in Database A |
| | of detail in Database A | Database A is not | is high enough; if the |
| | | high enough then | level of detail in |
| | | summarize at a macro | Database A is not high |
| | | level (e.g., network | enough then summarize |
| | | without regard to day- | at a mid-level (e.g., |
| | | part, program, etc.) | network by day-part); if |
| | | | the level of detail in |
| | | | Database A is still not |
| | | | high enough then |
| | | | summarize at a macro |
| | | | level (e.g., network |
| | | | without regard to day- |
| | | | part, program, etc.) |
| Large (about $8 | Most macro level of | Most micro level of | Most micro level of |
| million+) | summary possible | summary possible | summary possible (e.g., |
| | (e.g., network without | (e.g., network by day- | network by day-part by |
| | regard to day-part, | part by program), | program, and in some |
| | program, etc.), | regardless of the level | cases even by cable |
| | regardless of the level | of detail in Database A | system), regardless of |
| | of detail in Database A | | the level of detail in |
| | | | Database A |

If the size of the media buyer's budget is small relative to the cost per Gross Rating Point, (e.g., less than about $1 million in the case of television advertising; the number can be different for radio or other media channels), OR if the number of cases in Database A is small (less than about 1,500 cases), it has been found that the preferred way to summarize the viewing data may be at the most macro-level possible (e.g., by network only, without regard to day-part or program or any more detailed level of information), irrespective of the level of detail about viewing habits available in Database A. This is because even if the data in Database A provides a high level of detail, the media buyer may have the budget to engage in highly targeted advertising buying, which is much more expensive to undertake than buys that are less targeted, and the number of cases is too small to undertake a more detailed analysis with any degree of statistical reliability.

If the media buyer's budget is somewhat larger, (e.g., between about $1 million and about $8 million in the case of television advertising; the number can be different for radio or other media channels), and the number of cases in Database A is moderate or large (in excess of about 1,500 cases), it has been found that the preferred method of summarizing the data may be to the media buyer may wish to summarize the viewing data at a level that is more detailed than above if the level of detail about viewing habits provided in Database A is high enough to make this feasible. In such a circumstance, the optimal method for summarizing the viewing data may depend on the level of detail of the data from Database A and the number of cases in Database A.

In the situation described above (that is, the media buyer has a budget between about $1 million and about $8 million in the case of television advertising; the number can be different for radio or other media channels), if the number of cases is modest (about 1,500-about 3,000 cases), then it has been found that the preferred method for summarizing the viewing data may be by network by day-part, if the level of detail in Database A is high enough. If the level of detail in Database A is not high enough then the data can be summarized at a more macro-level (e.g., by network but not by day part).

In the situation described above (that is, the media buyer has a budget between about $1 million and about $8 million in the case of television advertising; the number can be different for radio or other media channels), if the number of cases is large (more than about 3,000 cases), then it has been found that the preferred method for summarizing the viewing data may be at the most micro-level possible, based on the level of detail in Database A. Thus, if the data in Database A is high, then it the preferred method of summarizing the data is likely to be by network by day-part by program, and even possibly by cable system. If the data in Database A provides information about network and day-part but not program, then the preferred method for summarizing the data is likely to be by network and day-part since this is the most micro-level of summary possible with the data provided.

If the media buyer's budget is large (e.g., more than about $8 million in the case of television advertising; the number can be different for radio or other media channels), and the number of cases is “medium” or “large” (about 1,500 or more), then it has been found that the preferred method of summarizing the viewing data may be at a level that is even more detailed than in the example above if the level of detail about viewing habits provided in Database A is high enough to make this feasible. For example, assuming the level of detail provided in Database A is high enough, it may be preferred to summarize data by network by day-part by program.

If the media buyer's budget is large, and the level of detail about viewing habits in Database A is high, and the number of cases is large (about 3,000 or more) and the media buy can take place in more than one cable system, it may be preferred to summarize by network by day-part by program by cable system, which is an even more micro- (higher) level of detail.

For other advertising channels, budget size, level of detail, and number of cases would still be the relevant criteria, but the manner in which “level of detail” is expressed may vary. For example, for radio, the relevant possible levels of detail would be station, station by day-part, station by day-part by program, station by day-part by program by radio system, and so on.

Other embodiments include summarizing by network but not by day-part; summarizing by day-part but not by network; summarizing by the 3-hour day-part intervals used by Nielsen or another data provider rather than the day-part time blocks used to by television; summarizing the same way for broadcast and cable; summarizing different ways for broadcast and cable, weighting broadcast viewing to account for a fixed percentage of television viewing, and weighting cable viewing to account for a fixed percentage of television viewing.

If the data in Database A arrives already in a format in which optimally recoding and summarizing the data is not necessary, users may be able to skip step 4 below.

### 2. Matching the Media Consumption Data to Another Database:

Next, the data from Database A is matched to another database. This database is referred to as Database B. The information contained in this database need not be limited to demographics. In fact, the information contained in Database B can include, but is not limited to, demographic information, information about the neighborhood in which the individual lives, home ownership, employment status, location, party registration, microtargeting scores or models, models of other attributes or behaviors, vote history, purchase history, government licenses including licenses issued for certain recreations or occupations, geographic, consumer, attitudinal, behavioral data, other data of public record, or data that can be purchased, traded, or otherwise acquired. The data in database B can be any level, including but not limited to individual-level, household-level, or smallest unit of measure (e.g., neighborhood-level, county-level, state-level, etc).

Databases A and B are combined together to provide Database C.

For steps 3-5 described hereinbelow, Databases B and C are set aside and only Database A is used.

This matching step can be optional in some embodiments. For example, users who are seeking to identify which television programs tend to be watched by similar groups of individuals, but are not specifically interested in the relative proportion of targets or non-targets in each buy, may not need to execute this step. As another example, in some embodiments, a database such as that described as Database B above may not be available.

### 3. Aggregate by Individual, Household, or Smallest Unit of Measure:

In Database A, data by individual, household, or smallest unit of measure can be aggregated, if necessary.

If the data in Database A was individual-level data, the data can be aggregated so that each row of data represents one individual from one household, rather than each row of data representing one item of media consumption during one day at one time by one individual. (See Example 1).

If the data in Database A was household-level data, the data can be aggregated so that each row of data represents one household, rather than each row of data representing one item of media consumption during one day at one time by one household.

If the smallest unit of measure available was not individual or household-level data, but rather another unit of measure, then the data should be aggregated so that each row represents the media consumed during one day-part by one unit. For example, if the smallest unit of measure available is a county, then the data should be aggregated so that each row represents the media consumed during one day-part by one county. In some embodiments, media consumption by day-part may not be available. In these embodiments, the data can be aggregated so that each row represents the media consumed by one unit.

Aggregation can be conducted by using a standard aggregation process in SPSS® but can also be conducted by using any standard commercially available software with any standard aggregation function.

If the data in Database A is from a source other than Nielsen that utilizes a different format, it may not be necessary to aggregate by individual, household, or smallest unit of measure, as it may already arrive aggregated by individual, household, or smallest unit of measure. In this case, the media buyer can skip step 3 and go to step 4.

### 4. Recoding the Media Consumption Data:

Next, the data in Database A can be recoded into variables summarizing the viewing data according to the optimal method of summarizing the data (see Table A above). This recoding step is optional and not necessary in instances where the data in Database A does not need to be recoded.

According to one embodiment, recoding of data may vary based on factors which include, but are not limited to: (i) the location in which the media buying will take place; (ii) the size of the geographic location in which the media buying will take place; (iii) the source of the individual-level data used in the analysis; (iv) the level of detail provided in the individual-level data used in the analysis; (v) whether the analysis includes cable or broadcast or both; (vi) the media buyer's budget to spend on television advertising.

It has also been found that regardless of the method of summarizing the viewing data selected above, it is in some circumstances preferable to recode the data to indicate the amount of television watched, rather than just whether or not television was watched at all. As an example to illustrate the difference between indicating the amount of television watched and indicating whether or not television was watched, consider examining the network by day-part ABC 8 PM through 11 PM Monday through Friday. If the user indicates the amount of television watched by a certain individual, the buyer might record “6 hours,” because according to Database A in this example, the individual might have watched ABC between 8 PM and 11 PM for about 3 hours on Tuesday, about 2 hours on Wednesday, and about 1 hour on Friday, for a total of about 6 hours. Thus, about “6 hours” indicates the amount of television watched by this individual. If the user simply wants to indicate whether or not ABC was watched at all by the individual between 8 PM and 11 PM between Monday and Friday, one would code the aforementioned individual as a “1” and code all individuals who did not watch ABC during this timeframe as a “0,” thus indicating in a binary fashion only whether or not television was watched on ABC during this timeframe rather than how much television was watched on television during this timeframe. Therefore, if the data are recoded to indicate only whether or not television was watched rather than the amount of television watched, an individual who watched 6 hours of television on ABC between 8 PM and 11 PM between Monday and Friday and an individual about 2 hours of television on ABC between 8 PM and 11 PM between Monday and Friday would both be coded the same way (with a “1”).

Whether it is better to recode the data to indicate the amount of television watched or just whether or not television was watched at all may depend on the media buying project at hand and the nature and size of Database A. The presence of a large number of outlying data points, for example, may make it preferable to recode the viewing data according to whether or not the television was watched at all during that network during that day-part rather than the amount of television watched during that network during that day-part. If sparse or less-detailed viewing data is the only data that can be obtained above then again it may be preferable to recode the viewing data according to whether or not the television was watched at all during that network during that day-part rather than the amount of television watched during that network during that day-part. Media buyers who are unsure which technique is optimal can try both and examine the cluster output in order to determine which the best method may be.

It has been found that when summarizing by network by day-part, the preferred way to summarize such data involves defining day-part differently for each network and system according to how television advertising time is sold. So, for instance, if primetime advertising on FOX is sold as a block that runs from 8-10 pm, but primetime advertising on NBC is sold as a block that runs from 8-11 pm, “prime time” these stations would be coded differently to reflect the way television advertising is sold differently on each station. Saturdays and Sundays are each coded separately from one another and from Monday-Friday, again reflecting the blocks in which television advertising time is sold.

At this point in the process, the original media consumption data that can be optionally removed, leaving the data optimally recoded as described hereinabove. For example, the original individual-level, household-level, or smallest unit of measure viewing data (used to produce the recoded viewing variables by network by day-part) are removed from the data, such that the data contains only the recoded data representing the amount of television watched by summarized according to the optimal method for summarizing the viewing data, as determined above. This new data is referred to as Database A2.

### 5. Create Clusters Based on Media Consumption Habits:

The next step is to cluster individuals, households, or smallest units of measure (depending on the type of data provided in Database A) based on their unique media consumption habits according to the recoded data obtained from step 4. In the case of this example, it is to cluster individuals based on their unique combination of television viewing patterns.

In order to create clusters based on media consumption habits, a computer program has been created by the Applicant which is referred to throughout this disclosure as SmartBuy™, which is a clustering computer program. SmartBuy™ is hereinafter referred to as “the computer program”.

There are several key features of the computer program:

(a) Not forcing every individual, household, or smallest unit of measure into a cluster—some individuals may remain “unclustered” if their attributes are deemed too different from the rest of the data to fit well into any cluster. This decision ensures that outliers can be prevented from unnecessarily altering what would be an otherwise potentially optimal cluster solution for the non-outlying cases. This decision privileges a cluster solution comprised of clusters that are distinct and “far apart” from one another (in n-dimensional space according to the distance function selected—see below) over the need to fit every individual into a cluster. The number of cases that might be not be able to fit into a cluster can range from zero to the total number of cases in the data, inclusive. Typically, the number of unclustered cases is a small proportion of the data (less than about 5%).

(b) Allowing the media buyer to optimally select the type of distance function, agglomeration rules, clustering approach, and clustering rules necessary to produce the best possible clusters for the particular contours of the data.

(c) The computer program is an unsupervised learning algorithm.

(d) The computer program allows the user to select the clustering approach. In one embodiment, it was found that the preferred clustering approach was a hierarchical clustering approach (See, for example, Cluster Analysis for Researchers, by H. Charles Romesburg (2004)). For a definition of hierarchical clustering, see, for example Id. at 315. For a step-by-step explanation of how to implement hierarchical cluster analysis, see, for example, Id. at pages 9-28. For a list of common features found in hierarchical cluster analysis, see, for example, Id. at pages 29-37. Optionally, see also Finding Groups in Data: An Introduction to Cluster Analysis, by Leonard Kaufman and Peter J. Rousseeuw (2005) pages 44-50. In other embodiments, other clustering approaches may be used including but not limited to a partitioning approach (for a definition of portioning approach, see for example Finding Groups in Data: An Introduction to Cluster Analysis, by Leonard Kaufman and Peter J. Rousseeuw (2005) pages 38-42), fuzzy clustering (See for example Finding Groups in Data: An Introduction to Cluster Analysis, by Leonard Kaufman and Peter J. Rousseeuw (2005), pages 42-44), or model-based clustering. For a definition of model-based clustering, see, for example, C. Fraley and A. E. Raftery. Model-based clustering, discriminant analysis, and density estimation. Journal of the American Statistical Association, 97:611-631 (2002).

(e) Next, the user selects the optimal distance function, based on a variety of factors including but not limited to the scope of the media buying project at hand, the nature and size of Database A2, the size of the location in which the advertising can ultimately be purchased, the nature of the individual-level viewing data that underlies the recoded variables in Database A2. In one embodiment, it was found that the preferred distance function was a Euclidean distance function. In other embodiments, other distance functions may be preferred, which may include but are not limited to: a minimum distance function, maximum distance function, or Manhattan distance function may be preferred. (For definitions of the different types of distance functions, see for example Finding Groups in Data: An Introduction to Cluster Analysis, by Leonard Kaufman and Peter J. Rousseeuw, pages 11-16 (2005)).

(f) The computer program also allows the user to select the optimal agglomeration method. In one embodiment, it was found that the preferred agglomeration method was a “complete linkage” method. In other embodiments, a “single linkage,” “average linkage” or “ward linkage” method may be preferred (See for example “Complexities of Hierarchic Clustering Algorithms: State of the Art” by F. Murtagh, Computational Statistics Quarterly, Vol 1, Issue 2, 1984, or Finding Groups in Data: An Introduction to Cluster Analysis, by Leonard Kaufman and Peter J. Rousseeuw, page 47 (2005)).

(g) The computer program outputs a variety of diagnostic statistics that allow the media buyer to determine whether the cluster solution is mathematically optimal for the data on hand. These diagnostic statistics can be used in conjunction with other factors, including but not limited to the media buyer's own judgment about the utility of a certain solution in light of the substantive goals of the project, to select the optimal clustering solution.

(h) The computer program allows the cluster solution to be validated in a variety of different ways (see below).

(i) This computer program can run on a UNIX platform with multiple processors.

(j) The computer program allows the media buyer to select the minimum acceptable cluster size (in other words, the minimum number of cases that may constitute a stand-alone cluster).

(k) The computer program allows the media buyer to select the sensitivity threshold for the creation of new clusters. For example, two potential clusters, located relatively proximate to one another in n-dimensional space (“relatively proximate” defined according to the distance function selected by the media buyer), both of a size greater than the minimum number of cases necessary to form a cluster, could each remain as independent cluster, or could be merged into one mega-cluster. The sensitivity threshold allows the media buyer to set in place rules that make the judgment as to whether those two proximate clusters should remain separate or be merged.

The following steps show how the computer program is used.

(A) First, Database A2 is loaded into the computer program.

(B) Next, the media buyer selects the optimal distance function, based on a variety of factors including but not limited to the scope of the media buying project at hand, the nature and size of Database A2, the size of the location in which the advertising can ultimately be purchased, the nature of the individual-level, household-level, or smallest unit of measure viewing data that underlies the recoded variables in Database A2. In one embodiment, it was found that the preferred distance function was a Euclidean distance function. In other embodiments, a minimum distance function, maximum distance function, or Manhattan distance function may be preferred.

(C) Next, the media buyer selects the optimal agglomeration method. In one embodiment, it was found that the preferred agglomeration method was a “complete linkage” method. In other embodiments, a “single linkage,” “average linkage” or “ward linkage” method may be preferred.

(D) Next, the media buyer selects the minimum cluster size, which represents the minimum number of cases required to form a cluster. Technically, the program allows the input of any integer from one to the maximum number of cases in the data, inclusive.

Typically, a media buyer can optimize the selection of minimum cluster size. In order to do this, the media buyer may wish to try a variety of different minimum cluster sizes an select the one that gives the optimal solution for given the number of cases in Database A and the size of the media budget. The smaller the number of cases in Database A, the larger the minimum cluster size may need to be to have statistical validity. The larger the media budget, the smaller the minimum cluster size can be because the media buyer may be more likely to be able to afford extremely targeted advertising buying. In general, regardless of the number of cases in Database A, a minimum cluster size of less than about, for example, 30, and a minimum cluster size of more than about, for example, 150, is likely not desirable.

Other factors that may influence the optimal minimum cluster size include (i) the location in which the media buying will take place; (ii) the size of the geographic location in which the media buying will take place; (iii) the source of the viewing data used in the analysis; (iv) the level of detail provided in the viewing data used in the analysis; (v) whether the analysis includes cable or broadcast or both; (vi) the media buyer's budget to spend on television advertising.

(E) Next, the media buyer selects the method for pruning smaller clusters. The appropriate method can depend on the nature of the media buying project at hand and the particular data. In one embodiment, it was found that the preferred method to use was “tree”. In other embodiments, a “hybrid” method was used. (For definition of these methods, see for example Langfelder P, Zhang B, Horvath S (2007) Defining clusters from a hierarchical cluster tree: the Dynamic Tree Cut library for R. Bioinformatics 2008 24(5):719-720). If the media buyer is unsure of the method to use, the media buyer can try both methods and examine the resulting output. The media buyer can select the method that produces clusters that are relatively similar in size, as opposed to one large cluster and many smaller clusters. Occasionally, both methods can produce one large cluster and many smaller clusters; in this situation, either method can be used.

(F) Next, the media buyer selects the sensitivity level. Typically, a media buyer can try a variety of different sensitivity levels and then select the one that gives the optimal solution for a particular media buying project at hand and a particular data. The sensitivity level usually takes on an integer value between zero and four, inclusive. Typically media buyers can try every possible sensitivity level and examine the output to determine which method produces clusters that are of optimal size for the media buying project at hand at hand.

(G) Typically, the media buyer may not make any of the selections in steps (B) through (F) in isolation, but rather may try different combinations of different distance functions, agglomeration methods, clustering approach, minimum cluster sizes, pruning methods, and sensitivity levels in order to find the optimal combination for a particular media buying project at hand given the particular contours (in n-dimensional space) of the particular data. This step can include reviewing the cluster solution for logical consistency, optionally using a rules-based system, wherein any cluster solution which appears to have more than about 10% of clusters that are not logically consistent is flagged for review.

Steps (B) through (F) could also be automated to generate every possible permutation and/or combination of distance functions, agglomeration methods, clustering approach, minimum cluster sizes, pruning methods, and sensitivity levels, after which the media buyer could select the optimal one from the diagnostic output provided after clustering using each permutation or combination of selections.

(H) Run the clustering program based on the selections made above.

(I) Examine the diagnostic output.

(J) Repeat until a cluster solution appears to be “mathematically plausible” as a cluster solution. A solution is considered “mathematically plausible” if: (i) the ratio of the distance between clusters relative to the distance within clusters is maximized, according to the distance function selected above; (ii) the silwidth (ratio of the distance between clusters to the distance within clusters, according to the distance function selected above) is larger than other potential cluster solutions; (iii) the clusters are of a size and proportion to one another that would prove substantively useful to the media buying project at hand; (iv) the size of the “unclustered” cluster is small enough that the media buyer deems it acceptable (what constitutes an acceptable number of unclustered cases depends on the nature of the media buying project at hand and the contours of the data, but typically is less than 5% of the cases).

(K) Once a cluster solution appears mathematically plausible, it may optionally be validated. In the preferred embodiment, the cluster solution is validated. The cluster solution can be validated in the following non-mutually-exclusive ways:

(i) Adjust the minimum cluster size to be about 5-10 cases larger and about 5-10 cases smaller than the minimum cluster size in the mathematically plausible solution. The resulting cluster solution should remain essentially unchanged for all but a small number of clusters. “Small number” is relative to the number of total clusters, but is usually not more than about 15% of the total clusters.

(ii) Bootstrap the data and try re-clustering to see if the solution looks approximately the same.

(L) Review the cluster solution for logical consistency, optionally using a rules-based system, wherein any cluster solution which appears to have more than about 10% of clusters that are not logically consistent is flagged for review.

(M) The final cluster solution is saved onto Database A2 as the final column of data, resulting in Database A3. See, for example, Example 3. The cluster solution assigns every individual on the file to exactly 1 cluster, delineated with a number between 1 and j, where j is the total number of clusters. Unclustered cases are indicated with a “0” in place of the cluster number.

### 6. Create Demographic/Attitudinal/Behavioral Profiles for Each Cluster:

Database A3 is then joined to Database C using the unique identifier for each case assigned earlier. This allows examination of all of the characteristics of each cluster based on the information originally contained in Database B.

Profiles can be created for each cluster by running any number of descriptive statistical algorithms such as frequencies, cross-tabulations, means, medians, modes, correlations, etc. A basic example would be to identify the proportion of each cluster that are female, the proportion that are young, or the median income of the cluster. A more advanced example would be to identify the proportion of each cluster comprised of wealthy women over 50 who have multiple frequent flier accounts. The media buyer could examine any characteristic or series of characteristics from Database B.

Thus, creating a profile for the cluster can simply involve creating a detailed spreadsheet that summarizes all of the characteristics in Database B for each cluster. The clusters having profiles are referred to as defined clusters.

This step can be optional in some embodiments where optional step 2 is not executed. It is also possible in some cases where step 2 is executed that the user may still wish to skip step 6 because, for example, the user may not specifically be interested in the relative proportion of targets or non-targets in each buy.

### 7. Identify Clusters to Target for Advertising:

Based on the profiles created in step 6, the media buyer can identify which clusters to target for advertising. The clusters targeted for advertising by the media buyer can be a subset of the defined clusters identified in step 6. The media buyer may wish to target clusters with a high proportion of targeted individuals relative to non-targeted individuals. For example, in the context of political advertising, the media buyer may wish to target the clusters with the largest number of unaffiliated or independent voters and the fewest number of strong partisans of either party. In the commercial marketplace, for example, a company selling organic baby food may wish to target clusters that have the largest number of wealthy liberal married women with children and the fewest number of other individuals.

Identifying the clusters to target simply involves making a list of the clusters (identified by number) that the media buyer wishes to target with advertising.

This step can be optional in some embodiments if step 6 is optionally not carried out. Step 6 enables the user to identify the proportion of targets and non-targets within each cluster, so that this information may be used to determine which clusters to target for a media buy.

In embodiments where the user does not carry out step 6, the user can have several options: (i) make the determination of which clusters to target for a media buy on an arbitrary basis; (ii) determine through some other metric which clusters to target for a media buy; or (iii) target all of the clusters for a media buy.

### 8. Create Media Consumption Profiles for Each Cluster:

In order to determine a good way to reach these targeted clusters, the media buyer can next create media consumption profiles for each cluster. As an example, television advertising is examined, however the media can include the examples provided hereinabove.

(A) To create the media consumption profile for each cluster, Database A3 is used to calculate the percentage of each cluster that watches television during each on each network at whatever level of detail was used to summarize the data in step 4. See, for example, Example 1.

(B) Rank the network by day-part in order from the most to least coverage within each targeted cluster. (See Table 6 in Example 1).

The media consumption profiles can be generated for non-targeted clusters, if desired. In preferred embodiments, however, media consumption profiles are only generated for targeted clusters.

### 9. Examine the Spill-Over for Each Potential Buy:

From the analysis in step 8(B) above, it can be determined which network by day-part segments can give the media buyer(s) the best coverage with the target cluster. Next, the non-targets being reached with each potential network by day-part buy can be optionally determined.

For example, it may be that a particular buy reaches 70% of one of the targeted clusters, but that target cluster makes up only 4% of the population, and thus that advertising buy might mainly reach individuals who are not in the target cluster. A primetime broadcast buy is a good example of this: it may reach a large proportion of the target cluster but it also may reach a large proportion of the population as a whole, meaning that the media buyer would mainly be paying for impressions from his or her non-target audience. The purpose of the advertising-buying optimization system is to be reaching “purer” groups of individuals, composed of a high proportion of individuals the media buyer can reach and a low proportion of individuals the media buyer does not choose to target.

In order to examine what proportion of non-targets can be receiving impressions with any given network by whatever level of detail was used to summarize the data in step 4, a separate table can be created that tells the media buyer the proportion of targets and non-targets reached by each potential buy. See, for example, Example 1.

This step can be optional in some embodiments. For example, if the user is concerned about achieving maximum coverage of the targeted individuals, but is less concerned with the “spill-over,” that is the proportion of non-targets that are included in the media buy, this step may not be necessary. As another example, some users may have such a large media budget that the coverage of non-targets is of less concern.

### 10. Attaching Cost to Each Potential Buy:

Next, optionally, advertising costs can be appended to each potential buy based on the coverage for each cluster with the proportion of targets and non-targets known for each potential buy. See, for example, Example 1.

If the advertising media is television, for example, the industry standard is to express advertising costs in Gross Rating Points.

It is also possible to purchase advertising within any given timeslot for a particular slot or program or for a particular day, that is, getting much more specific than “ABC 8 p-10:59 p Monday through Friday”. For example, a media buyer could specifically buy the television program “Grey's Anatomy,” which typically airs on ABC Thursdays from 9 PM through 10 PM. As another example, a media buyer could buy advertising time during all ABC programming airing on Thursday nights between 8 PM and 11 PM. Here average cost per Gross Rating Point across the entire time slot is utilized, but the media buyer could optionally instead make this specific to the day, program, and program slot (that is, when within the program the advertisement is aired).

Not all media buyers may wish to select to include cost information in this system. For example, this may occur because the media buyer does not have access to cost information, or because the media buyer has such a large media budget that the media buyer finds cost largely irrelevant, or because the media buyer is more concerned with getting sufficient coverage for targets than with minimizing cost. In this case, the media buyer can skip to step 11.

### 11. Select the Advertising Buy:

The media buyer may likely purchase the potential buy that has the highest coverage within the target cluster, optionally the lowest coverage of non-targets, and, optionally, the lowest cost for the potential buy. These judgments can be made subjectively by the media buyer or can be fed into a constrained optimization program. The optimization program could be any commercially available computer program, such as Microsoft Excel, SPSS®, SAS®, STATA®, or any other commercially-available software optimization program. In some embodiments, the media buyer could write his or her own optimization program in R or another program.

The best advertising buys may preferably have high coverage at low cost across multiple clusters, but low coverage among non-target clusters, thereby making the buy more “pure,” that is, the buy may preferably reach a high proportion of targets relative to non-targets. However, if a buy is relatively inexpensive, as determined by the media buyer, the media buyer may wish to purchase such buy, even if it only reaches one of the target clusters and/or it reaches several non-targets.

If the media buyer has a certain budget for a buy on broadcast television and a separate budget for cable, in that case the media buyer may wish to create two separate tables in steps 8(B) and 10 above for each target cluster (one for cable and one for broadcast), and optimize the advertising buy within broadcast and cable separately, treating cable and broadcast as quasi-separate media channels. If the media buyer does not have specific budget guidelines for broadcast and specific guidelines for a budget for cable, but rather general budget guidelines for television advertising, then cable and broadcast should be analyzed together.

Some buyers may have certain times of day or days of the week when they have determined that they want to advertise. These determinations may be made arbitrarily or based on judgments made outside the context of the method, system, and apparatus described herein. In this situation, the media buyer may use this method, system, and apparatus to determine the optimal advertising buys within the parameters determined by the buyer. Thus, the buyer may select the buy that has the highest coverage within a target cluster, optionally the lowest coverage of non-targets, and optionally, the lowest cost, within the parameters determined by the buyer. For example, the media buyer determines that he wants to make an advertising buy during the 5 PM through 6:30 PM Monday through Friday time slot on broadcast television, and the buyer simply seeks to determine which broadcast network to advertise on. In this case, the media buyer may select the network with the highest coverage within the targeted clusters, optionally the lowest coverage of non-targets, and optionally, the lowest cost.

### 12. Final Product:

The final product is a rank-ordered list of optimal buys for the media buyer. The media buyer can start with the optimal buy (i.e., the buy that reaches a large proportion of target clusters, a small proportion of non-targets overall, and has a low cost). The media buyer can then go to the next optimal buy, and so on to select one or more buys based on the media buyer's specific advertising goals.

The optimized advertising buying method outlined above allows the media buyer to select one or more buys that (i) reach a large proportion of target clusters, (ii) reach a small proportion of non-targets overall, and (iii) have a low cost.

Optimization Method for Advertising Buying is Provided in which a Media Buyer has a Budget for the Entire Multi-Channel Campaign, but has not Specified How the Budget will be Divided Among the Various Channels in the Campaign

In the steps hereinbelow another optimization method for advertising buying is provided in which a media buyer has a budget for the entire multi-channel campaign, but has not specified how the budget will be divided among the various channels in the campaign. For example, a media buyer who has about $20 million to spend on a multi-channel campaign but does not specify how the budget will be divided between the channels would be classified as a media buyer having a budget for the entire multi-channel campaign, but has not specified how the budget will be divided among the various channels in the campaign. The steps hereinbelow are similar to those described above for optimizing advertising buying in a method in which a media buyer has a budget for each channel in a multi-channel campaign.

Unless specified otherwise, the features in steps 1-12 described above for optimizing advertising buying in a method in which a media buyer has a budget for each channel in a multi-channel campaign, are the same as steps 1-12 described hereinbelow.

### 1. Obtaining the Data on Media Consumption:

Obtain individual-level, household-level, or smallest unit of measure data on media consumption in all media channels for which data can be obtained. This data for each channel may be compiled from different sources or optionally all of the data may come from the same source. The data on media consumption may include some or all of the following information: whether or not any media from that channel was consumed, the day of the week the media was consumed, the date the media was consumed, the time of day the media was consumed, the channel in which the media was consumed, the quantity of media consumed, the specific program during which the media was consumed (if applicable), the station on which the program aired (if applicable), the location in which the media was consumed (if applicable) and any other information needed to identify the context in which the media was consumed.

The level of detail about media consumption may vary by channel. For example, for television and radio, one may have detailed program-specific information about what media was consumed, while in the case of outdoor advertising, one may simply know whether or not the individual was exposed to outdoor advertising generally, as opposed to the specifics of day, time, and location.

Any data source(s) that provides individual-level, household-level, or smallest unit of measure data on media consumption can be used. This data is hereinafter referred to as Database A.

As an example, Database A could include media consumption data for four channels: (i) television, (ii) radio, (iii) outdoor advertising, and (iv) Internet banner advertising.

### 2. Matching the Media Consumption Data to Another Database:

Next, the data from Database A is matched to another database. This database is referred to as Database B. The information contained in this database need not be limited to demographics. In fact, the information contained in Database B can include, but is not limited to, demographic information, information about the neighborhood in which the individual lives, home ownership, employment status, location, party registration, microtargeting scores or models, models of other attributes or behaviors, vote history, purchase history, government licenses including licenses issued for certain recreations or occupations, geographic, consumer, attitudinal, behavioral data, other data of public record, or data that can be purchased, traded, or otherwise acquired. The data in database B can be any level, including but not limited to individual-level, household-level, or smallest unit of measure (e.g., neighborhood-level, county-level, state-level, etc).

Databases A and B are combined together to provide Database C.

For steps 3-5 described hereinbelow, Databases B and C are set aside and only Database A is used.

This matching step can be optional in some embodiments. For example, users who are seeking to identify which kinds of media consumption patterns tend to be common across groups of individuals, but are not specifically interested in the relative proportion of targets or non-targets in each media buy, may not need to execute this step. As another example, in some embodiments, a database such as that described as Database B above may not be available.

### 3. Aggregate by Individual, Household, or Smallest Unit of Measure:

In Database A, data by individual, household, or smallest unit of measure is aggregated, if necessary.

If the data in Database A was individual-level data, the data can be aggregated so that each row of data represents one individual from one household, rather than each row of data representing one item of media consumption during one day at one time by one individual. (See Example 3).

If the data in Database A was household-level data, the data can be aggregated so that each row of data represents one household, rather than each row of data representing one item of media consumption during one day at one time by one household.

If the smallest unit of measure available was not individual or household-level data, but rather another unit of measure, then the data should be aggregated so that each row represents the media consumed during one day-part by one unit. For example, if the smallest unit of measure available is a county, then the data should be aggregated so that each row represents the media consumed during one day-part by one county. In some embodiments, media consumption by day-part may not be available. In these embodiments, the data can be aggregated so that each row represents the media consumed by one unit.

Aggregation can be conducted by using a standard aggregation process in SPSS® but can also be conducted by using any standard commercially-available software with any standard aggregation function.

In some cases, it may not be necessary to aggregate by individual or by household or by smallest unit of measure, as the data may already arrive aggregated by individual or household or smallest unit of measure. In this case, the media buyer can skip step 3 and go to step 4.

### 4. Recoding the Media Consumption Data:

Next, the data in Database A is recoded into variables summarizing the media consumption data.

It has been found that the preferred method for recoding or summarizing the data depends on three factors: (1) the size of the media buyer's budget for a specific advertising campaign, (2) the level of detail about media consumption available in the data from Database A, and (3) the number of cases in Database A, as described in Table A above.

“Level of detail” in this case means the amount of information one has about what specific media the individual, household, or smallest unit of measure consumed. For instance, in some cases, Database A may provide only information about what whether or not media from a particular channel was consumed, whereas in other cases Database A may provide information about not only whether or not the media was consumed but also the day of the week and/or time of the day the individual, household, or smallest unit of measure consumed that media. In still other cases, Database A may provide information program and location (if applicable). Bear in mind that the “level of detail” may vary by channel, depending on the nature of the data acquired for consumption in each channel. As an example, for the channel of television, the data might have a high level of detail, including the network, day of the week, day-part and program, whereas for the channel of banner advertising, the data might have a low level of detail, including only whether or not the individual was exposed to banner advertising on a particular website, as opposed to the specific day of the week or time of day of the exposure. As a another example, for the channel of television, the data might have a high level of detail, including the network, day of the week, day-part and program, and for the channel of banner advertising, the data might also have a high level of detail, including only whether or not the individual was exposed to banner advertising on a particular website, as well as the specific day of the week or time of day of the exposure, as well as the location in which the exposure took place (zip code, type of web browser, etc.).

“Number of cases” refers to the number of individuals in Database A. In situations where Database A is household-level data, “number of cases” refers to the number of households in Database A. In situations where the data in Database A is provided at some level other than the individual or household-level, “number of cases” refers to the smallest unit of measure in which media consumption data is captured. In this multi-channel description, “number of cases” refers to the total number of units in the data, where each unit represents the smallest unit of measure in which the media consumption data is captured across all channels.

“Micro” level of summary in this case is defined as the detailed way of summarizing the data, based on the level of detail provided in Database A about media consumption habits. For example, if the detailed information one has about media consumption in Database A is simply whether or not media from that channel was consumed and the day of the week on which the consumption took place, then summarizing the media consumption data by whether or not media from that channel was consumed and the day of the week on which that consumption took place is the most “micro” level summary possible. If, however, the detailed information one has about viewing in Database A includes not only whether or not the media was consumed and the day of the week during which the media was consumed, but also the time of day, and program or location information (where applicable), then the micro-level summary possible involves summarizing the media consumption data by day of the week consumed, time of the day consumed, program consumed, and location information (where applicable).

“Macro” level of summary in this case refers to the broadest possible way to summarize the data. One example might be to summarize the data by whether or not media from a particular channel was consumed at all at any point during the time that the data was collected for Database A. Specific examples would include whether or not television was watched at all, whether or not radio was listened to at all, whether or not the individual was exposed to billboard advertising, whether or not the individual was exposed to Internet banner advertising, and so on.

According to one embodiment, recoding of data may vary based on factors which include, but are not limited to: (i) the location in which the media buying will take place; (ii) the size of the geographic location in which the media buying will take place; (iii) the source of the individual-level, household-level, or smallest unit of measure data used in the analysis; (iv) the level of detail provided in the individual-level, household-level, or smallest unit of measure data used in the analysis; (v) the number of channels included in the analysis; (vi) the media buyer's total multi-channel budget.

It has also been found that regardless of the method of summarizing the media consumption data selected in above, it is in some circumstances preferable to recode the data to indicate the amount of media consumed at whatever the optimized summary level is, rather than just whether or not the media was consumed at all. As an example, that would involve recoding the data from Database A to show how many banner advertisements an individual, household, or smallest unit of measure was exposed to on a particular day during a particular time, as opposed to whether or not the individual, household, or smallest unit of measure was exposed at all. Which method is more effective may depend on the media buying project at hand and the nature and size of Database A. The presence of a large number of outlying data points, for example, may make it preferable to recode the media consumption data according to whether or not media from that channel was consumed at all during that day of the week or time of the day, rather than the amount of media consumed during that day of the week or time of the day. If sparse or less-detailed media consumption data is the only data that can be obtained above then again it may be preferable to recode the viewing data according to whether or not media from that channel was consumed during that day of the week or time of the day, rather than the amount of media consumed during that day of the week or time of the day. Media buyers who are unsure which technique is optimal can try both and examine the cluster output in order to determine which the best method may be.

It has been found that when summarizing by channel by station (if applicable) by day of week and time of day, the preferred way to summarize such data involves defining “time of day” differently for each channel according to how advertising is sold in that medium. So, for example, in the channel of television, if primetime advertising on FOX is sold as a block that runs from 8-10 pm, but primetime advertising on NBC is sold as a block that runs from 8-11 pm, “prime time” these stations would be coded differently to reflect the way television advertising is sold differently on each station. Saturdays and Sundays are each coded separately from one another and from Monday-Friday, again reflecting the blocks in which television advertising time is sold. As another example, radio might be sold in different time blocks from television and would therefore need to be recoded differently. So, for example, radio advertising might be sold in different time blocks than television. For instance, for radio, one time slot might be “morning rush hour” (Monday-Friday, 6-10 am). For internet banner advertising, it is not possible to purchase advertising that appears visible during some times of the day and not others, and so for internet banner advertising, no “day-parts” may exist. Thus, the media recoding can differ for each channel according to how advertising is sold.

At this point in the process, the original media consumption data that can be optionally removed, leaving the data optimally recoded as described hereinabove. For example, the original individual-level, household-level, smallest unit of measure media consumption data (used to produce the recoded variables) are removed from the data, such that the data contains only the recoded data representing the amount of media consumed summarized according to the optimal method for summarizing the media consumption data, as determined above. This new data is referred to as Database A2.

### 5. Create Clusters Based on Media Consumption Habits:

The next step is to cluster individuals, households, or smallest unit of measure (depending on the type of data provided in Database A) based on their unique media consumption habits across all channels according to the recoded data obtained in step 4.

In order to create clusters based on media consumption habits, a computer program has been created by the Applicant which is referred to throughout this disclosure as SmartBuy™, which is a clustering computer program. SmartBuy™ is hereinafter referred to as “the computer program”.

The following steps show how the computer program is used in a multi-channel optimization context.

(A) First, Database A2 is loaded into the computer program. Note that this database includes recoded media consumption from all of the various channels that can be jointly optimized for the advertising buy.

(B) Next, the media buyer selects the optimal distance function, based on a variety of factors including but not limited to the scope of the media buying project at hand, the nature and size of Database A2, the size of the location in which the advertising can ultimately be purchased, the nature of the individual-level, household-level, or smallest unit of measure media consumption data that underlies the recoded variables in Database A2. In one embodiment, it was found that the preferred distance function was a Euclidean distance function. In other embodiments, a minimum distance function, maximum distance function, or Manhattan distance function may be preferred.

(C) Next, the media buyer selects the optimal agglomeration method. In one embodiment, it was found that the preferred agglomeration method was a “complete linkage” method. In other embodiments, a “single linkage,” “average linkage” or “ward linkage” method may be preferred.

(D) Next, the media buyer selects the minimum cluster size, which represents the minimum number of cases required to form a cluster. Technically, the program allows the input of any integer from one to the maximum number of cases in the data, inclusive.

Typically, a media buyer can optimize the selection of minimum cluster size. In order to do this, the media buyer may wish to try a variety of different minimum cluster sizes an select the one that gives the optimal solution for given the number of cases in Database A and the size of the media budget. The smaller the number of cases in Database A, the larger the minimum cluster size may need to be to have statistical validity. The larger the media budget, the smaller the minimum cluster size can be because the media buyer may be more likely to be able to afford extremely targeted advertising buying. In general, regardless of the number of cases in Database A, a minimum cluster size of less than about, for example, 30, and a minimum cluster size of more than about, for example, 150, is likely not desirable.

Other factors that may influence the optimal minimum cluster size include (i) the location in which the media buying will take place; (ii) the size of the geographic location in which the media buying will take place; (iii) the source of the media consumption data used in the analysis; (iv) the level of detail provided in the media consumption data used in the analysis; (v) the number of channels included in the analysis; (vi) the media buyer's total multi-channel budget.

(E) Next, the media buyer selects the method for pruning smaller clusters. The appropriate method may depend on the nature of the media buying project at hand and the particular data. In one embodiment, it was found that the preferred method to use was “tree”. In other embodiments, a “hybrid” method was used. If the media buyer is unsure of the method to use, the media buyer can try both methods and examine the output. The media buyer can select the method that produces clusters that are relatively similar in size, as opposed to one large cluster and many smaller clusters. Occasionally, both methods can produce one large cluster and many smaller clusters; in this situation, either method can be used.

(F) Next, the media buyer selects the sensitivity level. Typically, a media buyer can try a variety of different sensitivity levels and then select the one that gives the optimal solution for a particular media buying project at hand and a particular data. The sensitivity level usually takes on an integer value between zero and four, inclusive. Typically media buyers can try every possible sensitivity level and examine the output to determine which method produces clusters that are of optimal size for the media buying project at hand at hand.

(G) Typically, the media buyer may not make any of the selections in steps (B) through (F) in isolation, but rather try different combinations of different distance functions, agglomeration methods, clustering approach, minimum cluster sizes, pruning methods, and sensitivity levels in order to find the optimal combination for a particular media buying project at hand given the particular contours (in n-dimensional space) of the particular data. This step can include reviewing the cluster solution for logical consistency, optionally using a rules-based system, wherein any cluster solution which appears to have more than about 10% of clusters that are not logically consistent is flagged for review.

Steps (B) through (F) could also be automated to generate every possible permutation and/or combination of distance functions, agglomeration methods, clustering approach, minimum cluster sizes, pruning methods, and sensitivity levels, after which the media buyer could select the optimal one from the diagnostic output provided after clustering using each permutation or combination of selections.

(H) Run the clustering program based on the selections made above.

(I) Examine the diagnostic output.

(J) Repeat until a cluster solution appears to be “mathematically plausible” as a cluster solution. A solution is considered “mathematically plausible” if: (i) the ratio of the distance between clusters relative to the distance within clusters is maximized, according to the distance function selected above; (ii) the silwidth (ratio of the distance between clusters to the distance within clusters, according to the distance function selected above) is larger than other potential cluster solutions; (iii) the clusters are of a size and proportion to one another that would prove substantively useful to the media buying project at hand; (iv) the size of the “unclustered” cluster is small enough that the media buyer deems it acceptable (what constitutes an acceptable number of unclustered cases depends on the nature of the media buying project at hand and the contours of the data, but typically is less than 5% of the cases).

(K) Once a cluster solution appears mathematically plausible, it optimally may be validated. In the preferred embodiment, the cluster solution is validated. The cluster solution can be validated in the following non-mutually-exclusive ways:

(i) Adjust the minimum cluster size to be about 5-10 cases larger and about 5-10 cases smaller than the minimum cluster size in the mathematically plausible solution. The resulting cluster solution should remain essentially unchanged for all but a small number of clusters. “Small number” is relative to the number of total clusters, but is usually not more than about 15% of the total clusters.

(ii) Bootstrap the data and try re-clustering to see if the solution looks approximately the same.

(L) Review the cluster solution for logical consistency, optionally using a rules-based system, wherein any cluster solution which appears to have more than about 10% of clusters that are not logically consistent is flagged for review.

(M) The final cluster solution is saved onto Database A2 as the final column of data, resulting in Database A3. See, for example, Example 2. The cluster solution assigns every individual on the file to exactly 1 cluster, delineated with a number between 1 and j, where j is the total number of clusters. Unclustered cases are indicated with a “0” in place of the cluster number. In this multi-channel example, individuals, households, or smallest units of measure are clustered according to their unique multi-channel mix of media consumption patterns. Therefore, the cluster solution is found by grouping individuals, households, or smallest units of measure according to their media consumption patterns.

### 6. Create Demographic/Attitudinal/Behavioral Profiles for Each Cluster:

Database A3 is then joined to Database C using the unique identifier for each case assigned earlier. This allows us to examine all of the characteristics of each cluster based on the information originally contained in Database B.

Profiles can be created for each cluster by running any number of descriptive statistical algorithms such as frequencies, cross-tabulations, means, medians, modes, correlations, etc. A basic example would be to identify the proportion of each cluster that are female, the proportion that are young, or the median income of the cluster. A more advanced example would be to identify the proportion of each cluster comprised of wealthy women over 50 who have multiple frequent flier accounts. The media buyer could examine any characteristic or series of characteristics from Database B.

Thus, creating a profile for the cluster can simply involve creating a detailed spreadsheet that summarizes all of the characteristics in Database B for each cluster. The clusters having profiles are referred to as defined clusters.

This step can be optional in some embodiments where optional step 2 is not executed. It is also possible in some cases where step 2 is executed that the user may still wish to skip step 6 because, for example, the user is not specifically interested in the relative proportion of targets or non-targets in each buy.

### 7. Identify Clusters to Target for Advertising:

Based on the profiles created in step 6, the media buyer can identify which clusters to target for advertising. The clusters targeted for advertising by the media buyer can be a subset of the defined clusters identified in step 6. The media buyer may wish to target clusters with a high proportion of targeted individuals relative to non-targeted individuals. For example, in the context of political advertising, the media buyer may wish to target the clusters with the largest number of unaffiliated or independent voters and the fewest number of strong partisans of either party. In the commercial marketplace, for example, a company selling organic baby food may wish to target clusters that have the largest number of wealthy liberal married women with children and the fewest number of other individuals.

Identifying the clusters to target simply involves making a list of the clusters (identified by number) that the media buyer wishes to target with advertising.

This step can be optional in some embodiments if step 6 is optionally not carried out. Step 6 enables the user to identify the proportion of targets and non-targets within each cluster, so that this information may be used to determine which clusters to target for a media buy.

In embodiments whether the user does not carry out step 6, the user has several options: (i) make the determination of which clusters to target for a media buy on an arbitrary basis; (ii) determine through some other metric which clusters to target for a media buy; (iii) target all of the clusters for a media buy.

### 8. Create Media Consumption Profiles for Each Cluster:

In order to determine the best possible way to reach these targeted clusters, the media buyer can next create media consumption profiles for each cluster. In the multi-channel context, the media consumption profile for each cluster includes (i) which media channels were consumed; (ii) the amount of media consumed in each channel (optionally where possible); and (iii) (optionally where possible) a list of potential advertising buys for each channel in which media consumption took place for that cluster, at the level of detail in which the data was recoded in step 4 above.

(A) To create the media consumption profile for each cluster, Database A3 is used to calculate the percentage of each cluster that is reachable for each potential buy at whatever level of detail was summarized in step 4. So, for example, in a multi-channel context, one potential buy would be to purchase banner advertising on ESPN.com in a particular set of zip codes. In that situation, the proportion of cluster x reachable with that advertising buy is the proportion of cluster x that was exposed to banner advertising on ESPN.com according to Database A. As another example, in the multi-channel context, one potential buy would be WKGB radio in a particular set of zip codes during the morning show (6-10 am). In that situation, the proportion of cluster x reachable with that advertising buy is the proportion of cluster x in the specified set of zip codes that listened to WKGB during the morning show time slot according to Database A.

(B) Rank the list of potential advertising buys in order from the highest to lowest coverage within each targeted cluster.

The media consumption profiles can be generated for non-targeted clusters, if desired. In preferred embodiments, however, media consumption profiles are only generated for targeted clusters.

### 9. Examine the Spill-Over for Each Potential Buy:

From the analysis in step 8(B) above, it can be determined which advertising buys can give the media buyer(s) the best coverage with the target cluster. Next, the non-targets being reached with each potential network by day-part buy can optionally be determined.

For example, it may be that a particular buy reaches 70% of one of the targeted clusters, but that target cluster makes up only 4% of the population, and thus that advertising buy might mainly reach individuals who are not in the target cluster. A primetime broadcast buy is a good example of this: it may reach a large proportion of the target cluster but it also may reach a large proportion of the population as a whole, meaning that the media buyer would mainly be paying for impressions from his or her non-target audience. The purpose of the advertising-buying optimization system is to be reaching “purer” groups of individuals, composed of a high proportion of individuals the media buyer can reach and a low proportion of individuals the media buyer does not wish to target.

In order to examine what proportion of non-targets can be receiving impressions by whatever level of detail was used to summarize the media consumption data in step 4, a separate table can be created that tells the media buyer, the proportion of targets and non-targets reached by each potential advertising buy.

This step can be optional in some embodiments. For example, if the user is concerned about achieving maximum coverage of the targeted individuals, but is less concerned with the “spill-over,” that is the proportion of non-targets that are included in the media buy, this step may not be necessary. As another example, some users may have such a large media budget that the coverage of non-targets is of less concern.

10. Append cost per advertising buy to each potential advertising buy:

Next, optionally, advertising costs (industry standard for most advertising is to express this in cost per Gross Rating Point, but other metrics may be used for some channels) can be appended to each potential buy based on the coverage for each cluster with the proportion of targets and non-targets known for each potential buy.

Not all media buyers may want to or may be able to include cost information in this system. For example, this may occur because the media buyer does not have access to cost information, or because the media buyer has such a large media budget that the media buyer finds cost largely irrelevant, or because the media buyer is more concerned with getting sufficient coverage for targets than with minimizing cost, or possibly for other reasons. If the media buyer does not wish to examine cost information for each potential advertising buy, the media buyer can skip to step 11.

### 11. Select the Advertising Buy:

The media buyer may likely purchase the potential buy that has the highest coverage within the target cluster, optionally the lowest coverage of non-targets, and, optionally, the lowest cost for the potential buy for each cluster. These judgments can be made subjectively by the media buyer or can be fed into a constrained optimization program. The optimization program could be any commercially available computer program, such as Microsoft Excel, SPSS®, SAS®, STATA®, or any other commercially-available software optimization program. In some embodiments, the media buyer could write his or her own optimization program in R or another program. Optionally, in some cases, the media buyer may wish to select a potentially less efficient buy (“efficient” defined as highest coverage within the target cluster, the lowest coverage of non-targets, and, optionally, the lowest cost for the potential buy for each cluster) in order to ensure that all the different media channels in which the media buyer can advertise have at least one advertising buy.

The best advertising buys can preferably have high coverage at low cost across multiple clusters, but low coverage among non-target clusters, thereby making the buy more “pure,” that is, the buy can preferably reach a high proportion of targets relative to non-targets. However, if a buy is relatively inexpensive, as determined by the media buyer, the media buyer may wish to purchase such an advertising buy, even if it only reaches one of the target clusters and/or it reaches several non-targets.

If the media buyer has certain media channel in which they wish to advertise, the advertising buy for that channel with the highest coverage among targets along with the lowest coverage among non-targets and the lowest cost can be selected.

12. Final Product:

The final product is a rank-ordered list of optimal advertising buys for the media buyer. The media buyer can start with the optimal advertising buy (i.e., the advertising buy that reaches a large proportion of target clusters, a small proportion of non-targets overall, and has a low cost). The media buyer can then go to the next optimal buy, and so on to select one or more buys based on the media buyer's specific advertising goals.

The optimized advertising buying method outlined above allows the media buyer to select one or more buys that (i) reach a large proportion of target clusters, (ii) reach a small proportion of non-targets overall, and (iii) have a low cost.

It will now be apparent to those skilled in the art that this specification describes a new, useful, and nonobvious method, system, and apparatus for optimizing advertising-buying. It will also be apparent to those skilled in the art that numerous modifications, variations, substitutes, and equivalents exist for various aspects of the invention that have been described in the detailed description above. Accordingly, it is expressly intended that all such modifications, variations, substitutions, and equivalents that fall within the spirit and scope of the invention, as defined by the appended claims, be embraced thereby.

### EXAMPLES

### Example 1

This example shows how the method of optimizing television advertising-buying that can be carried out using Nielsen data. For example, when Nielsen data was acquired, it was presented in a format where each row of data represented one program watched on one network by one individual during one day-part, with the time within each three-hour day-part indicated by 12 separate variables, one for each quarter hour (see Table 1).

TABLE 1

| Household | Individual | Day | Network | Day-part | Qhs1 | Qhs2 | Qhs3 | Qhs4 | Qhs5 | . . . | Qhs12 |
|---|---|---|---|---|---|---|---|---|---|---|---|
| 0123 | 1 | Apr. 20 | HGTV | 6 a-8:59 a | 1 | 1 | 0 | 0 | 0 | | 0 |
| 0123 | 1 | Apr. 20 | COMCENT | 9 p-11:59 p | 0 | 0 | 0 | 0 | 1 | | 1 |
| 0123 | 1 | Apr. 21 | ABC | 9 a-11:59 a | 0 | 0 | 1 | 1 | 0 | | 0 |
| Etc . . . | | | | | | | | | | | |
| 0123 | 2 | Apr. 20 | CBS | 9 a-11:59 a | 1 | 1 | 1 | 1 | 1 | | 1 |
| 0123 | 2 | Apr. 20 | ESPN | 6 p-8:59 p | 1 | 1 | 0 | 0 | 0 | | 0 |
| 0123 | 2 | Apr. 20 | TLC | 6 p-8:59 p | 0 | 0 | 1 | 1 | 0 | | 0 |
| 0123 | 2 | Apr. 21 | ABC | 9 a-11.59 a | 1 | 1 | 1 | 1 | 0 | | 0 |
| 0123 | 2 | Apr. 21 | CBS | 12 p-2:59 p | 0 | 0 | 1 | 1 | 1 | | 1 |
| Etc . . . | | | | | | | | | | | |
| 0124 | 1 | Apr. 20 | NBC | 6 a-8:59 a | 1 | 1 | 1 | 1 | 0 | | 0 |
| 0124 | 1 | Apr. 20 | TNT | 6 p-8:59 p | 0 | 0 | 0 | 0 | 0 | | 1 |
| 0124 | 1 | Apr. 21 | TNT | 6 p-8:59p | 0 | 0 | 0 | 1 | 1 | | 0 |
| Etc . . . | | | | | | | | | | | |

Aggregation in this Example was conducted by using a standard aggregation process in SPSS®.

An example of data of the data format once aggregated by individual is shown below. Database A aggregated by individual is henceforth referred to as Database A1 and is shown hereinbelow in Table 2.

TABLE 2

| | | | | Day- | | | | | | Day- | | | |
|---|---|---|---|---|---|---|---|---|---|---|---|---|---|
| Household | Individual | Day | Ntwk | part | Qhs1 | Qhs2 | . . . | Day | Ntwk | part | Qhs1 | Qhs2 | . . . |
| 0123 | 1 | Apr. | HGTV | 6 a-8:59 a | 1 | 1 | | Apr. | COMCENT | 9 p-11:59 p | 0 | 0 | |
| | | 20 | | | | | | 20 | | | | | |
| 0123 | 2 | Apr. | CBS | 9 a-11:59 a | 1 | 1 | | Apr. | ESPN | 6 p-8:59 p | 1 | 1 | |
| | | 20 | | | | | | 20 | | | | | |
| 0124 | 1 | Apr. | NBC | 6 a-8:59 a | 1 | 1 | | Apr. | TNT | 6 p-8:59 p | 0 | 0 | |
| | | 20 | | | | | | 21 | | | | | |
| Etc . . . | | | | | | | | | | | | | |

Table 3, shown hereinbelow, indicates data recoded by network by day-part in the optimized manner as determined by the number of cases in Database A, the size of the media buyer's budget, and the level of detail provided in Database A. The original individual-level viewing data was removed to obtain Database A2.

TABLE 3

| | | HGTV- | HGTV- | HGTV- | | ESPN- | | ESPN- | | ABC- | |
|---|---|---|---|---|---|---|---|---|---|---|---|
| | | 6 a to 8:59 a | 9 a to 4:59 p | 5 p to 11:59 p | | 6 a to 8:59 a | | 9 a-4:59 p | | 5 a to 8:59 a | |
| Household | Individual | M-F | M-F | M-F | . . . | M-F | . . . | Sat | . . . | M-F | . . . |
| 0123 | 1 | 0.5 | 0 | 0 | | 0 | | 0 | | 0.5 | |
| 0123 | 2 | 0 | 0 | 0 | | 0 | | 0 | | 1 | |
| 0124 | 1 | 0 | 0 | 0 | | 0 | | 0 | | 0 | |
| Etc . . . | | | | | | | | | | | |

Table 4, shown hereinbelow, shows a sample format of Database A3 with cluster solution appended.

TABLE 4

| | | HGTV- | | ESPN- | | ESPN- | | | | |
|---|---|---|---|---|---|---|---|---|---|---|
| | | 6 a to 8:59 a | | 6 a to 8:59 a | | 6 a to 5:59 p | | ABC- | | |
| Household | Individual | M-F | . . . | M-F | . . . | Sat | . . . | 5 a to 8:59 a | . . . | Cluster |
| 0123 | 1 | 0.5 | | 0 | | 0 | | 0.5 | | 12 |
| 0123 | 2 | 0 | | 0 | | 0 | | 1 | | 6 |
| 0124 | 1 | 0 | | 0 | | 0 | | 0 | | 3 |
| Etc . . . | | | | | | | | | | |

Note that in Table 5, only the targeted clusters identified in step 7 are examined.

TABLE 5

| | Cluster 2 | Cluster 4 | Cluster 7 | Cluster 18 | . . . |
|---|---|---|---|---|---|
| ESPN | 3% | 1% | 31% | 1% | |
| 6 a-8:59 a | | | | | |
| ESPN | 1% | 1% | 18% | 1% | |
| 9 a-4:59 p | | | | | |
| ESPN | 2% | 0% | 25% | 0% | |
| 5 p-11:59 p | | | | | |
| Etc . . . | | | | | |
| FOOD | 1% | 12% | 1% | 0% | |
| 6 a-8:59 a | | | | | |
| FOOD | 2% | 25% | 0% | 0% | |
| 9 a-4:59 p | | | | | |
| FOOD | 2% | 21% | 0% | 0% | |
| 5 p-11:59 p | | | | | |
| Etc . . . | | | | | |
| CBS | 7% | 61% | 4% | 76% | |
| 6 a-8:59 a | | | | | |
| CBS | 35% | 11% | 1% | 10% | |
| 9 a-2:59 p | | | | | |
| CBS | 16% | 18% | 1% | 55% | |
| 3 p-4:59 p | | | | | |
| Etc . . . | | | | | |

Note that Table 6 shows network by day-part ranked by coverage by cluster for each targeted cluster. Here, Cluster 2 is an example of one of the targeted clusters.

TABLE 6

| | Cluster 2 |
|---|---|
| ABC 8 p-10:59 p M-F | 82% |
| FOX 8 p-9:59 p M-F | 75% |
| TNT 7 p-11:59 p M-F | 72% |
| ABC 6 a-11:59 a Sat | 55% |
| ESPN 6 a-5:59 p Sun | 40% |
| NBC 8 p-10:59 p M-F | 39% |
| Etc . . . | |

Table 7 shows a proportion of targets and non-targets reached by each network by day-party potential buy in the situation when the media buyer is trying to reach Democrats rather than Republicans, so the targets are Democrats and the non-targets are Republicans. In this example, it is assumed that the number of independent, unaffiliated voters and voters affiliated with another party are all zero.

TABLE 7

| | Democrats | Republicans |
|---|---|---|
| | (targets) | (non-targets) |
| ABC 8 p-10:59 p M-F | 60% | 35% |
| FOX 8 p-9:59 p M-F | 40% | 60% |
| TNT 7 p-11:59 p M-F | 50% | 35% |
| ABC 6 a-11:59 a Sat | 70% | 25% |
| ESPN 6 a-5:59 p Sun | 35% | 59% |
| NBC 8 p-10:59 p M-F | 25% | 55% |
| Etc . . . | | |

For a media buyer selling a particular commercial product, this would work the same way. For instance, for an media buyer selling organic baby food, the targets would be “wealthy liberal parents with infant children” and the non-targets would be “everyone else in the population.”

Table 8 below shows cost per Gross Rating Point information appended to network by day-part ranked by coverage for each cluster with the proportion of targets and non-targets known for each potential buy.

TABLE 8

| | | | | Cost per |
|---|---|---|---|---|
| | | | | Gross |
| | | Democrats | Republicans | Rating |
| | Cluster 2 | (targets) | (non-targets) | Point |
| ABC 8 p-10:59 p M-F | 82% | 60% | 35% | $397 |
| FOX 8 p-9:59 p M-F | 75% | 40% | 60% | $226 |
| TNT 7 p-11:59 p M-F | 72% | 50% | 35% | $55 |
| ABC 6 a-11:59 a Sat | 55% | 70% | 25% | $79 |
| ESPN 6 a-11:59 a | 40% | 35% | 59% | $42 |
| Sun | | | | |
| NBC 8 p-10:59 p M-F | 39% | 25% | 55% | $225 |
| Etc . . . | | | | |

In Table 8 shown hereinabove, TNT 7 p-11:59 p may be a good buy because it has high coverage within the target cluster (72%), overall reaches a high proportion of targets and a low proportion of non-targets, and has a relatively low cost ($55 per point).

In another instance, the media buyer may select FOX as the network of choice to advertise on M-F primetime compared with ABC because, for instance, the cost of ABC is more than 50% more than the cost of FOX, but FOX and ABC have almost the same coverage within cluster 2. However, FOX does reach a larger portion of non-targets overall. Accordingly, the media buyer may select the potential buy based on specific goals the media buyer may have.

### Example 2

This example shows how the method of optimizing television advertising-buying that can be carried out using Nielsen data for a commercial product.

In this example, the media buyer is trying to reach women age 40-64 to target for osteoporosis prevention medication.

For example, Nielsen data was presented in a format where each row of data represented one program watched on one network by one individual during one day-part, with the time within each three-hour day-part indicated by 12 separate variables, one for each quarter hour (see Table 9).

TABLE 9

| | | | | Day- | | | | | | | |
|---|---|---|---|---|---|---|---|---|---|---|---|
| Household | Individual | Day | Network | part | Qhs1 | Qhs2 | Qhs3 | Qhs4 | Qhs5 | . . . | Qhs12 |
| 0123 | 1 | Apr. | HGTV | 6 a-8:59 a | 1 | 1 | 0 | 0 | 0 | | 0 |
| | | 20 | | | | | | | | | |
| 0123 | 1 | Apr. | COMCENT | 9 p-11:59 p | 0 | 0 | 0 | 0 | 1 | | 1 |
| | | 20 | | | | | | | | | |
| 0123 | 1 | Apr. | ABC | 9 a-11:59 a | 0 | 0 | 1 | 1 | 0 | | 0 |
| | | 21 | | | | | | | | | |
| Etc . . . | | | | | | | | | | | |
| 0123 | 2 | Apr. | CBS | 9 a-11:59 a | 1 | 1 | 1 | 1 | 1 | | 1 |
| | | 20 | | | | | | | | | |
| 0123 | 2 | Apr. | ESPN | 6 p-8:59 p | 1 | 1 | 0 | 0 | 0 | | 0 |
| | | 20 | | | | | | | | | |
| 0123 | 2 | Apr. | TLC | 6 p-8:59 p | 0 | 0 | 1 | 1 | 0 | | 0 |
| | | 20 | | | | | | | | | |
| 0123 | 2 | Apr. | ABC | 9 a-11:59 a | 1 | 1 | 1 | 1 | 0 | | 0 |
| | | 21 | | | | | | | | | |
| 0123 | 2 | Apr. | CBS | 12 p-2:59 p | 0 | 0 | 1 | 1 | 1 | | 1 |
| | | 21 | | | | | | | | | |
| Etc . . . | | | | | | | | | | | |
| 0124 | 1 | Apr. | NBC | 6 a-8:59 a | 1 | 1 | 1 | 1 | 0 | | 0 |
| | | 20 | | | | | | | | | |
| 0124 | 1 | Apr. | TNT | 6 p-8:59 p | 0 | 0 | 0 | 0 | 0 | | 1 |
| | | 20 | | | | | | | | | |
| 0124 | 1 | Apr. | TNT | 6 p-8:59 p | 0 | 0 | 0 | 1 | 1 | | 0 |
| | | 21 | | | | | | | | | |
| Etc . . . | | | | | | | | | | | |

Aggregation in this Example was conducted by using a standard aggregation process in SPSS®.

An example of data of the data format, once aggregated by individual is shown below. Database A aggregated by individual is henceforth referred to as Database A1 and is shown hereinbelow in Table 10.

TABLE 10

| | | | | Day- | | | | | | Day- | | | |
|---|---|---|---|---|---|---|---|---|---|---|---|---|---|
| Household | Individual | Day | Ntwk | part | Qhs1 | Qhs2 | . . . | Day | Ntwk | part | Qhs1 | Qhs2 | . . . |
| 0123 | 1 | Apr. | HGTV | 6 a-8:59 a | 1 | 1 | | Apr. | COMCENT | 9 p-11:59 p | 0 | 0 | |
| | | 20 | | | | | | 20 | | | | | |
| 0123 | 2 | Apr. | CBS | 9 a-11:59 a | 1 | 1 | | Apr. | ESPN | 6 p-8:59 p | 1 | 1 | |
| | | 20 | | | | | | 20 | | | | | |
| 0124 | 1 | Apr. | NBC | 6 a-8:59 a | 1 | 1 | | Apr. | TNT | 6 p-8:59 p | 0 | 0 | |
| | | 20 | | | | | | 21 | | | | | |
| Etc . . . | | | | | | | | | | | | | |

Table 11, shown hereinbelow, indicates data recoded by network by day-part in the optimized manner as determined by the number of cases in Database A, the size of the media buyer's budget, and the level of detail provided in Database A. The original individual-level viewing data was removed to obtain Database A2.

TABLE 11

| | | HGTV- | HGTV- | HGTV- | | ESPN- | | ESPN- | | ABC- | |
|---|---|---|---|---|---|---|---|---|---|---|---|
| | | 6 a to 8:59 a | 9 a to 4:59 p | 5 p to 11:59 p | | 6 a to 8:59 a | | 9 a-4:59 p | | 5 a to 8:59 a | |
| Household | Individual | M-F | M-F | M-F | . . . | M-F | . . . | Sat | . . . | M-F | . . . |
| 0123 | 1 | 0.5 | 0 | 0 | | 0 | | 0 | | 0.5 | |
| 0123 | 2 | 0 | 0 | 0 | | 0 | | 0 | | 1 | |
| 0124 | 1 | 0 | 0 | 0 | | 0 | | 0 | | 0 | |
| Etc . . . | | | | | | | | | | | |

Table 12, shown hereinbelow, shows a sample format of Database A3 with cluster solution appended.

TABLE 12

| | | HGTV- | | ESPN- | | ESPN- | | | | |
|---|---|---|---|---|---|---|---|---|---|---|
| | | 6 a to 8:59 a | | 6 a to 8:59 a | | 6 a to 5:59 p | | ABC- | | |
| Household | Individual | M-F | . . . | M-F | . . . | Sat | . . . | 5 a to 8:59 a | . . . | Cluster |
| 0123 | 1 | 0.5 | | 0 | | 0 | | 0.5 | | 12 |
| 0123 | 2 | 0 | | 0 | | 0 | | 1 | | 6 |
| 0124 | 1 | 0 | | 0 | | 0 | | 0 | | 3 |
| Etc . . . | | | | | | | | | | |

Note that in Table 13, only the targeted clusters identified in step 7 are examined.

TABLE 13

| | Cluster 2 | Cluster 4 | Cluster 17 | Cluster 18 | . . . |
|---|---|---|---|---|---|
| HGTV | 3% | 1% | 31% | 1% | |
| 6 a-8:59 a M-F | | | | | |
| HGTV | 1% | 1% | 18% | 1% | |
| 9 a-4:59 p M-F | | | | | |
| HGTV | 2% | 0% | 25% | 0% | |
| 5 p-11:59 p M-F | | | | | |
| Etc . . . | | | | | |
| FOOD | 1% | 1% | 12% | 0% | |
| 6 a-8:59 a M-F | | | | | |
| FOOD | 2% | 0% | 25% | 0% | |
| 9 a-4:59 p M-F | | | | | |
| FOOD | 2% | 0% | 21% | 0% | |
| 5 p-11:59 p M-F | | | | | |
| Etc . . . | | | | | |
| CBS | 7% | 61% | 4% | 76% | |
| 6 a-8:59 a M-F | | | | | |
| CBS | 35% | 11% | 1% | 10% | |
| 9 a-2:59 p M-F | | | | | |
| CBS | 16% | 18% | 1% | 55% | |
| 3 p-4:59 p M-F | | | | | |
| Etc . . . | | | | | |

Note that Table 14 shows network by day-part ranked by coverage by cluster for each targeted cluster.

TABLE 14

| | Cluster 17 |
|---|---|
| ABC 8 p-10:59 p M-F | 82% |
| NBC 8 p-10:59 p M-F | 65% |
| ABC 6 a-11:59 a Sat | 55% |
| CBS 3 p-4:59 p M-F | 50% |
| HGTV 6 a-5:59 p Sat | 42% |
| FOOD 9 a-4:59 p M-F | 39% |
| Etc . . . | |

Table 15 shows a proportion of targets and non-targets reached by each network by day-party potential buy. Recall that in this example, the media buyer is trying to reach women age 40-64 to target for osteoporosis prevention medication. So in this example, women age 4-64 are the target, and all other individuals are non-targets. This step is optional. It would be possible to simply determine which buy to make based on Table 14 above, simply buying the networks that have the broadest coverage in the target clusters.

TABLE 15

| | Women | All other |
|---|---|---|
| | age 40-64 | individuals |
| | (targets) | (non-targets) |
| ABC 8 p-10:59 p M-F | 70% | 65% |
| NBC 8 p-10:59 p M-F | 30% | 40% |
| ABC 6 a-11:59 a Sat | 25% | 35% |
| CBS 3 p-4:59 p M-F | 60% | 45% |
| HGTV 6 a-5:59 p Sat | 10% | 3% |
| FOOD 9 a-4:59 p M-F | 5% | 15% |
| Etc . . . | | |

Table 16 below shows cost per Gross Rating Point information appended to network by day-part ranked by coverage for each cluster with the proportion of targets and non-targets known for each potential buy.

Note that this step is also optional. It would be possible to determine the optimal advertising buy without regard to cost, simply based on which buys get the best possible coverage within the target clusters.

It would also be possible to determine the optimal advertising buy without regard to cost, simply based on which buys get the best possible coverage within the target clusters and also according to which buys have the least spillover, that is to say, high coverage of targets overall and low coverage of non-targets.

TABLE 16

| | | | | Cost per |
|---|---|---|---|---|
| | | Women age | All other | Gross |
| | | 40-64 | individuals | Rating |
| | Cluster 17 | (targets) | (non-targets) | Point |
| ABC 8 p-10:59 p M-F | 82% | 70% | 65% | $397 |
| NBC 8 p-10:59 p M-F | 65% | 30% | 40% | $226 |
| ABC 6 a-11:59 a Sat | 55% | 25% | 35% | $205 |
| CBS 3 p-4:59 p M-F | 50% | 60% | 45% | $145 |
| HGTV 6 a-5:59 p Sat | 42% | 10% | 3% | $14 |
| FOOD 9 a-4:59 p M-F | 39% | 5% | 15% | $21 |
| Etc . . . | | | | |

In Table 16 shown hereinabove, HGTV 6 a-5:59 p Saturday may be a good buy because it has high coverage within the target cluster (42%), overall reaches a high proportion of targets relative to non-targets, and has a low cost ($14 per GRP).

In Table 16, shown hereinabove, even though overall FOOD 9 a-4:59 p M-F reaches a low proportion of targets relative to non-targets, it may also be a good buy because it has high coverage within the target cluster (39%), and has a low cost ($21 per GRP).

If the media buyer is determined to make a broadcast primetime advertising buy, despite the fact that it will reach a high proportion of non-targets relative to targets, the media buyer can select NBC as the network of choice to advertise on M-F primetime compared with ABC because, for instance, the cost of ABC is 75% more than the cost of NBC, but NBC has coverage that is only 17 percentage points lower within cluster 17. Accordingly, the media buyer can select the potential buy based on specific goals the media buyer may have.

### Example 3

This example shows how the method of optimizing television advertising-buying that can be carried out using Nielsen data for a commercial product.

The optimization method, system, and apparatus described herein can be used not only to optimally purchase television advertising, but also to determine the optimal mix of advertising on various media channels.

Here “media channel” refers to any of the types of media referred to in the definition of “media” hereinabove.

This example shows how the method of optimizing advertising buying can be carried out to determine what mix of media channels to buy using data from several different sources. This example is for a media buyer wishing to advertise a new soy-based organic energy bar. The target audience is upscale men and women between the ages of 18 and 39 with an interest in organic products.

Data on media consumption habits for individuals is acquired from different sources for each media channel.

For example, the television viewing data came from Nielsen, and was presented in a format where each row of data represented one program watched on one network by one individual during one day-part, with the time within each three-hour day-part indicated by 12 separate variables, one for each quarter hour (see Table 17 on the following page).

TABLE 17

| | | | | Day- | | | | | | | |
|---|---|---|---|---|---|---|---|---|---|---|---|
| Household | Individual | Day | Network | part | Qhs1 | Qhs2 | Qhs3 | Qhs4 | Qhs5 | . . . | Qhs12 |
| 0123 | 1 | Apr. | HGTV | 6 a-8:59 a | 1 | 1 | 0 | 0 | 0 | | 0 |
| | | 20 | | | | | | | | | |
| 0123 | 1 | Apr. | COMCENT | 9 p-11:59 p | 0 | 0 | 0 | 0 | 1 | | 1 |
| | | 20 | | | | | | | | | |
| 0123 | 1 | Apr. | ABC | 9 a-11:59 a | 0 | 0 | 1 | 1 | 0 | | 0 |
| | | 21 | | | | | | | | | |
| Etc . . . | | | | | | | | | | | |
| 0123 | 2 | Apr. | CBS | 9 a-11:59 a | 1 | 1 | 1 | 1 | 1 | | 1 |
| | | 20 | | | | | | | | | |
| 0123 | 2 | Apr. | ESPN | 6 p-8:59 p | 1 | 1 | 0 | 0 | 0 | | 0 |
| | | 20 | | | | | | | | | |
| 0123 | 2 | Apr. | TLC | 6 p-8:59 p | 0 | 0 | 1 | 1 | 0 | | 0 |
| | | 20 | | | | | | | | | |
| 0123 | 2 | Apr. | ABC | 9 a-11:59 a | 1 | 1 | 1 | 1 | 0 | | 0 |
| | | 21 | | | | | | | | | |
| 0123 | 2 | Apr. | CBS | 12 p-2:59 p | 0 | 0 | 1 | 1 | 1 | | 1 |
| | | 21 | | | | | | | | | |
| Etc . . . | | | | | | | | | | | |
| 0124 | 1 | Apr. | NBC | 6 a-8:59 a | 1 | 1 | 1 | 1 | 0 | | 0 |
| | | 20 | | | | | | | | | |
| 0124 | 1 | Apr. | TNT | 6 p-8:59 p | 0 | 0 | 0 | 0 | 0 | | 1 |
| | | 20 | | | | | | | | | |
| 0124 | 1 | Apr. | TNT | 6 p-8:59 p | 0 | 0 | 0 | 1 | 1 | | 0 |
| | | 21 | | | | | | | | | |
| Etc . . . | | | | | | | | | | | |

The television viewing data was then aggregated by individual. Aggregation in this example was conducted by using a standard aggregation process in SPSS®.

An example of data of the data format, once the television data was aggregated by individual is shown below. Database A aggregated by individual is henceforth referred to as Database A1a and is shown hereinbelow in Table 18.

TABLE 18

| | | | | Day- | | | | | | Day- | | | |
|---|---|---|---|---|---|---|---|---|---|---|---|---|---|
| Household | Individual | Day | Ntwk | part | Qhs1 | Qhs2 | . . . | Day | Ntwk | part | Qhs1 | Qhs2 | . . . |
| 0123 | 1 | Apr. | HGTV | 6 a-8:59 a | 1 | 1 | | Apr. | COMCENT | 9 p-11:59 p | 0 | 0 | |
| | | 20 | | | | | | 20 | | | | | |
| 0123 | 2 | Apr. | CBS | 9 a-11:59 a | 1 | 1 | | Apr. | ESPN | 6 p-8:59 p | 1 | 1 | |
| | | 20 | | | | | | 20 | | | | | |
| 0124 | 1 | Apr. | NBC | 6 a-8:59 a | 1 | 1 | | Apr. | TNT | 6 p-8:59 p | 0 | 0 | |
| | | 20 | | | | | | 21 | | | | | |
| Etc . . . | | | | | | | | | | | | | |

In this example, data on radio consumption was obtained from Arbitron Inc., which is a media and marketing research firm serving the media—radio, television, cable, online radio and out-of-home—as well as advertisers and advertising agencies in the United States. Optionally, data on radio consumption could come from the same source as data on television viewing patterns, or could come from a different source.

In this example, the data on ratio consumption was presented in a format where each row of data represented one radio program listened to on one station by one individual during one day-part, with the time within each three-hour day-part indicated by 12 separate variables, one for each quarter hour (see Table 19 on the following page).

TABLE 19

| | | | | | Day- | | | | | | | |
|---|---|---|---|---|---|---|---|---|---|---|---|---|
| Household | Individual | Day | Station | AM/FM | part | Qhs1 | Qhs2 | Qhs3 | Qhs4 | Qhs5 | . . . | Qhs12 |
| 0123 | 1 | Apr. | WAMU | AM | 6 a-8:59 a | 1 | 1 | 0 | 0 | 0 | | 0 |
| | | 20 | | | | | | | | | | |
| 0123 | 1 | Apr. | WKGB | FM | 9 p-11:59 p | 0 | 0 | 0 | 0 | 1 | | 1 |
| | | 20 | | | | | | | | | | |
| 0123 | 1 | Apr. | WKGB | FM | 9a-11:59 a | 0 | 0 | 1 | 1 | 0 | | 0 |
| | | 21 | | | | | | | | | | |
| Etc . . . | | | | | | | | | | | | |
| 0123 | 2 | Apr. | WAMU | AM | 9 a-11:59 a | 1 | 1 | 1 | 1 | 1 | | 1 |
| | | 20 | | | | | | | | | | |
| 0123 | 2 | Apr. | WBZQ | FM | 6 p-8:59 p | 1 | 1 | 0 | 0 | 0 | | 0 |
| | | 20 | | | | | | | | | | |
| 0123 | 2 | Apr. | WKRS | FM | 6 p-8:59 p | 0 | 0 | 1 | 1 | 0 | | 0 |
| | | 20 | | | | | | | | | | |
| 0123 | 2 | Apr. | WAMU | AM | 9 a-11:59 a | 1 | 1 | 1 | 1 | 0 | | 0 |
| | | 21 | | | | | | | | | | |
| 0123 | 2 | Apr. | WTTP | AM | 12 p-2:59 p | 0 | 0 | 1 | 1 | 1 | | 1 |
| | | 21 | | | | | | | | | | |
| Etc . . . | | | | | | | | | | | | |
| 0124 | 1 | Apr. | WKRS | FM | 6 a-8:59 a | 1 | 1 | 1 | 1 | 0 | | 0 |
| | | 20 | | | | | | | | | | |
| 0124 | 1 | Apr. | WKRS | FM | 6 p-8:59p | 0 | 0 | 0 | 0 | 0 | | 1 |
| | | 20 | | | | | | | | | | |
| 0124 | 1 | Apr. | WKRS | FM | 6 p-8:59 p | 0 | 0 | 0 | 1 | 1 | | 0 |
| | | 21 | | | | | | | | | | |
| Etc . . . | | | | | | | | | | | | |

The radio consumption data was then aggregated by individual. Aggregation in this example was conducted by using a standard aggregation process in SPSS®.

An example of data of the data format, once the radio consumption data was aggregated by individual is shown below. Database A aggregated by individual is henceforth referred to as Database A1b and is shown hereinbelow in Table 20.

TABLE 20

| | | | | Day- | | | | | | Day- | | | |
|---|---|---|---|---|---|---|---|---|---|---|---|---|---|
| Household | Individual | Day | Station | part | Qhs1 | Qhs2 | . . . | Day | Station | part | Qhs1 | Qhs2 | . . . |
| 0123 | 1 | Apr. | WAMU | 6 a-8:59 a | 1 | 1 | | Apr. | WKGB | 9 p-11:59 p | 0 | 0 | |
| | | 20 | | | | | | 20 | | | | | |
| 0123 | 2 | Apr. | WAMU | 9 a-11:59 a | 1 | 1 | | Apr. | WBZQ | 6 p-8:59 p | 1 | 1 | |
| | | 20 | | | | | | 20 | | | | | |
| 0124 | 1 | Apr. | WKRS | 6 a-8:59 a | 1 | 1 | | Apr. | WKRS | 6 p-8:59 p | 0 | 0 | |
| | | 20 | | | | | | 21 | | | | | |
| Etc . . . | | | | | | | | | | | | | |

Databases A1a and A1b are then optionally joined together to form database A1, which has all of the media consumption for each individual in all channels aggregated by individual.

TABLE 21

| | | | TELEVISION | | | | | | | RADIO | | | |
|---|---|---|---|---|---|---|---|---|---|---|---|---|---|
| House- | Indi- | | | Day- | | | | Day- | | | Day- | | |
| hold | vidual | Day | Ntwk | part | Qhs1 | Day | Ntwk | part | Qhs1 | Station | part | Qhs1 | Qhs2 |
| 0123 | 1 | Apr. | HGTV | 6 a-8:59 a | 1 | Apr. | COMCENT | 9 p-11:59 p | 0 | WKGB | 9 p-11:59 p | 0 | 0 |
| | | 20 | | | | 20 | | | | | | | |
| 0123 | 2 | Apr. | CBS | 9 a-11:59 a | 1 | Apr. | ESPN | 6 p-8:59 p | 1 | WBZQ | 6 p-8:59 p | 1 | 1 |
| | | 20 | | | | 20 | | | | | | | |
| 0124 | 1 | Apr. | NBC | 6 a-8:59 a | 1 | Apr. | TNT | 6 p-8:59 p | 0 | WKRS | 6 p-8:59 p | 0 | 0 |
| | | 20 | | | | 21 | | | | | | | |
| Etc . . . | | | | | | | | | | | | | |

Table 22, shown hereinbelow, indicates the television viewing data was recoded by network by day-part in the optimized manner as determined by the number of cases in Database A for the television viewing data, the size of the media buyer's budget, and the level of detail provided in Database A for the television viewing data (see Detailed Description section above).

Table 22, shown hereinbelow, indicates the radio consumption data was also recoded by station by day-part in the optimized manner, as determined by the number of cases in Database A for the radio consumption data, the size of the media buyer's budget, and the level of detail provided in Database A for the radio consumption data (see Detailed Description section above).

Note that in this particular case, the radio consumption data and television viewing data were recoded into similar intervals. This may not always be the case, depending on the nature of the data in Database A for television viewing and radio consumption.

The original individual-level television viewing data and radio consumption data were removed to obtain Database A2.

TABLE 22

| | | TELEVISION | | | | RADIO | | |
|---|---|---|---|---|---|---|---|---|
| | | HGTV- | HGTV- | ESPN- | ABC- | WAMU- | WKGB- | WKRS- |
| | | 6 a to 8:59 a | 9 a to 4:59 p | 6 a to 8:59 a | 5 a to 8:59 a | 6 a to 8:59 a | 6 a to 8:59 a | 5 a to 8:59 a |
| Household | Individual | M-F | M-F | M-F | M-F | M-F | M-F | M-F |
| 0123 | 1 | 0.5 | 0 | 0 | 0.5 | 0.5 | 0 | 0.5 |
| 0123 | 2 | 0 | 0 | 0 | 1 | 0 | 0 | 1 |
| 0124 | 1 | 0 | 0 | 0 | 0 | 0 | 0 | 0 |
| Etc . . . | | | | | | | | |

Table 23, shown hereinbelow, shows a sample format of Database A3 with cluster solution appended. Each individual is assigned a cluster based on his or her unique media consumption habits. Each cluster is assigned a designated number. Note that in this case, the cluster solution would be based both upon the individual's television viewing habits and upon the individual's radio consumption habits. Thus two individuals with identical television watching habits but non-identical radio listening habits are likely to be put in two separate clusters. Note also that two individuals with identical radio listening habits but non-identical television viewing habits are likely to be put in two separate clusters.

TABLE 23

| | | HGTV- | HGTV- | ESPN- | ABC- | WAMU- | WKGB- | WKRS- | |
|---|---|---|---|---|---|---|---|---|---|
| | | 6 a to 8:59 a | 9 a to 4:59 p | 6 a to 8:59 a | 5 a to 8:59 a | 6 a to 8:59 a | 6 a to 8:59 a | 5 a to 8:59 a | |
| Household | Individual | M-F | M-F | M-F | M-F | M-F | M-F | M-F | Cluster |
| 0123 | 1 | 0.5 | 0 | 0 | 0.5 | 0.5 | 0 | 0.5 | 4 |
| 0123 | 2 | 0 | 0 | 0 | 1 | 0 | 0 | 1 | 17 |
| 0124 | 1 | 0 | 0 | 0 | 0 | 0 | 0 | 0 | 3 |
| Etc . . . | | | | | | | | | |

The next step is to examine the demographic/attitudinal/behavioral composition of each cluster in order to determine which clusters to select to target with advertising. This is accomplished by examining the proportion of targets and non-targets in each cluster by matching the cluster solution to Database B, which contains demographic/attitudinal/behavioral information about each individual in Database A. Table 24 hereinbelow shows the results of this analysis. Recall that in this example, the target audience is upscale men and women between the ages of 18 and 39 with an interest in organic products. Note that this step is optional.

TABLE 24

| | Upscale individuals | |
|---|---|---|
| | age 18-39 | |
| | with an interest in | All other |
| | organic products | individuals |
| Cluster | (targets) | (non-targets) |
| 1 | 8% | 92% |
| 2 | 14% | 86% |
| 3 | 2% | 98% |
| 4 | 6% | 94% |
| 5 | 1% | 99% |
| 6 | 0% | 100% |
| Etc . . . | | |

As the table above shows, few individuals in the population fall into the category of upscale individuals between the ages of 18 and 39 with an interest in organic products. Thus, no single cluster has a high concentration of the targets relative to the non-targets. That said, clearly some clusters are better to select for advertising than others. For instance, cluster 2 has 14% of individuals falling into the target category, which makes it the best cluster to target for advertising (of those listed in Table 24 above). Conversely, cluster 6 features no individuals in the target category: 100% of those in cluster 6 are non-targets. Therefore, cluster 6 would be a poor choice to select to target for advertising.

With a large media budget, the media buyer can target clusters that have a poorer ratio of targets to non-targets than media buyers with a smaller media budget will be able to afford. For example, in the example herein, a media buyer with an extremely limited budget may wish to only select cluster 2, whereas a media buyer with a larger budget may wish to select clusters 1 and 2, since cluster 1 has the second-best ratio of targets to non-targets. The media buyer with an even larger budget may elect to advertise to clusters 1, 2, and 4, since cluster 4 has the third-best ratio of targets to non-targets in the data.

Thus, in this step, the media buyer will wish to select those clusters that have the highest concentration of targets relative to non-targets according to the size of the media buyer's total budget. The media buyer will make a list of these clusters.

The next step is to determine the media consumption patterns of these targeted clusters. This is done by creating media consumption profiles for each of the targeted clusters. Table 25 on the following page shows an example of what media consumption profiles by cluster might look like. Note that in Table 25 (see the following page), only the targeted clusters identified in step 7 are examined.

TABLE 25

| | | Cluster 2 | Cluster 4 | . . . |
|---|---|---|---|---|
| Television | HGTV | 3% | 14% | |
| | 6 a-8:59 a M-F | | | |
| | HGTV | 1% | 1% | |
| | 9 a-4:59 p M-F | | | |
| | HGTV | 2% | 0% | |
| | 5 p-11:59 p M-F | | | |
| | Etc . . . | | | |
| | CBS | 7% | 61% | |
| | 6 a-8:59 a M-F | | | |
| | CBS | 35% | 11% | |
| | 9 a-2:59 p M-F | | | |
| | CBS | 50% | 18% | |
| | 3 p-4:59 p M-F | | | |
| | FOOD | 19% | 1% | |
| | 6 a-8:59 a M-F | | | |
| | FOOD | 2% | 11% | |
| | 9 a-4:59 p M-F | | | |
| | FOOD | 2% | 0% | |
| | 5 p-11:59 p M-F | | | |
| Radio | WAMU | 17% | 3% | |
| | 6 a to 8:59 a M-F | | | |
| | WAMU | 14% | 1% | |
| | 9 a-4:59 p M-F | | | |
| | WAMU | 0% | 1% | |
| | 5 p-11:59 p M-F | | | |
| | WKGB- | 3% | 21% | |
| | 6 a to 8:59 a M-F | | | |
| | WKGB | 0% | 14% | |
| | 9 a-4:59 p M-F | | | |
| | WKGB | 1% | 3% | |
| | 5 p-11:59 p M-F | | | |
| | Etc . . . | | | |

Note that Table 26 shows each potential television and radio buy ranked by coverage by cluster for each targeted cluster.

TABLE 26

| | | Cluster 2 |
|---|---|---|
| Television | ABC 8 p-10:59 p M-F | 75% |
| | CBS 8 p-10:59 p M-F | 64% |
| | CBS 3 p-4:59 p M-F | 50% |
| | FOOD 6 a-5:59 p Sat | 19% |
| Radio | WAMU 6 a to 8:59 a M-F | 17% |
| | WAMU 9 a-4:59 p M-F | 14% |
| | WTTS 6 a to 8:59 a M-F | 13% |
| | Etc . . . | |
| | | Cluster 4 |
| Television | ABC 8 p-10:59 p M-F | 82% |
| | NBC 8 p-10:59 p M-F | 65% |
| | ABC 6 a-11:59 a Sat | 55% |
| | CBS 3 p-4:59 p M-F | 50% |
| | HGTV 6 a-5:59 p Sat | 14% |
| | FOOD 9 a-4:59 p M-F | 11% |
| Radio | WKGB 6 a to 8:59 a M-F | 21% |
| | WKGB 9 a-4:59 p M-F | 14% |
| | WTPP 6 a to 8:59 a M-F | 12% |
| | Etc . . . | |

Table 27 shows a proportion of targets and non-targets reached by each network by day-party potential buy. Recall that this is to gauge the “spillover” from each potential buy. Each buy will reach some targets and some non-targets; the question is how much of each. Note that this step is optional.

Recall that in this example, the target audience is upscale men and women between the ages of 18 and 39 with an interest in organic products. So in this example, individuals between the ages of 18 and 39 with an interest in organic products are the targets, and all other individuals are non-targets.

TABLE 27

| | | Upscale | |
|---|---|---|---|
| | | individuals | |
| | | age 18-39 | |
| | | with an | |
| | | interest in | All other |
| | | organic | individuals |
| | | products | (non- |
| | | (targets) | targets) |
| Television | ABC 8 p-10:59 p M-F | 7% | 93% |
| | NBC 8 p-10:59 p M-F | 3% | 97% |
| | ABC 6 a-11:59 a Sat | 2% | 98% |
| | CBS 3 p-4:59 p M-F | 6% | 94% |
| | HGTV 6 a-5:59 p Sat | 10% | 90% |
| | FOOD 9 a-4:59 p M-F | 1% | 99% |
| Radio | WKGB 6 a to 8:59 a M-F | 7% | 93% |
| | WKGB 9 a-4:59 p M-F | 10% | 90% |
| | WTPP 6 ato8:59 a M-F | 12% | 88% |
| | WAMU 6 ato8:59 a M-F | 4% | 96% |
| | WAMU 9 ato4:59 p M-F | 1% | 99% |
| | WTTS 6 ato8:59 a M-F | 0% | 100% |
| | Etc . . . | | |

Table 28 below shows cost per buy information appended to the rank-ordered list of potential buys ranked by within-cluster coverage for each cluster with the proportion of targets and non-targets known for each potential buy. Cost per buy is typically expressed in GRPs. Note that this step is optional—some media buyers may be less price sensitive and may simply select the buys on the basis of coverage.

TABLE 28

| | | | Upscale | | |
|---|---|---|---|---|---|
| | | | individuals | | |
| | | | age 18-39 | | |
| | | | with an | | |
| | | | interest in | All other | |
| | | | organic | individuals | |
| | | | products | (non- | Cost per |
| | | Cluster 2 | (targets) | targets) | buy |
| Television | ABC 8 p-10:59 p M-F | 75% | 7% | 93% | $397 |
| | CBS 8 p-10:59 p M-F | 64% | 3% | 97% | $226 |
| | CBS 3 p-4:59 p M-F | 50% | 6% | 94% | $145 |
| | FOOD 6 a-5:59 p Sat | 19% | 3% | 97% | $20 |
| Radio | WAMU 6 a to 8:59 a M-F | 17% | 4% | 96% | $21 |
| | WAMU 9 a-4:59 p M-F | 14% | 1% | 99% | $11 |
| | WTTS 6 a to 8:59 a M-F | 13% | 0% | 100% | $61 |
| | Etc . . . | | | | |

TABLE 29

| | | | Upscale | | |
|---|---|---|---|---|---|
| | | | individuals | | |
| | | | age 18-39 | | |
| | | | with an | | |
| | | | interest in | All other | |
| | | | organic | individuals | |
| | | | products | (non- | Cost per |
| | | Cluster 4 | (targets) | targets) | buy |
| Television | ABC 8 p-10:59 p M-F | 82% | 7% | 93% | $397 |
| | NBC 8 p-10:59 p M-F | 65% | 3% | 97% | $226 |
| | ABC 6 a-11:59 a Sat | 55% | 2% | 98% | $205 |
| | CBS 3 p-4:59 p M-F | 50% | 6% | 94% | $145 |
| | HGTV 6 a-5:59 p Sat | 14% | 10% | 90% | $14 |
| | FOOD 9 a-4:59 p M-F | 11% | 1% | 99% | $21 |
| Radio | WKGB 6 a to 8:59 a M-F | 21% | 7% | 93% | $31 |
| | WKGB 9 a-4:59 p M-F | 14% | 10% | 90% | $29 |
| | WTPP 6 a to 8:59 a M-F | 12% | 12% | 88% | $45 |
| | WAMU 6 a to 8:59 a M-F | 3% | 4% | 96% | $21 |
| | WAMU 9 a to 4:59 p M-F | 1% | 1% | 99% | $11 |
| | WTTS 6 a to 8:59 a M-F | 1% | 0% | 100% | $61 |
| | Etc . . . | | | | |

In Table 29, shown hereinabove, even though overall FOOD 9 a-4:59 p M-F reaches a low proportion of targets relative to non-targets, it may also be an efficient advertising buy because it has reasonably high coverage within one of the target cluster (cluster 4, above—11%), and has a low cost ($21 per GRP). Similarly, FOOD 6 a-5:59 p Sat may also be an efficient advertising buy because it has reasonably high coverage within one of the target clusters (cluster 2, above), and has a low cost ($20 per GRP).

In this example hereinabove, it is possible that the media buyer will wish to divert some resources away from broadcast television towards cable television, since the coverage of targets relative to non-targets may be higher than for broadcast, in the case of some advertising buys. For example, HGTV 6 a-5:59 p Sat has a relatively high ratio of targets to non-targets in this example above, compared to a much lower ratio of targets to non-targets for more widely watched advertising network by day-part options such as NBC 8 p-10:59 p M-F.

Similarly, in this example hereinabove, it is possible that the media buyer will wish to divert some resources away from broadcast television or cable television towards some advertising buys on radio, since the coverage of targets relative to non-targets may be higher for some radio buys than for either broadcast television or cable television, and often the radio buys are cheaper in terms of cost per GRP.

The present invention has been described by way of the foregoing exemplary embodiments to which it is not limited. Variations and modifications will occur to those skilled in the art that do not depart from the scope of the invention as recited in the claims appended thereto.

What is claimed is:

1. A method for optimizing advertising buying for one or more media buyers having a budget for each channel in a single or a multi-channel campaign, comprising:
creating clusters based on media consumption habits of individuals;
creating media consumption profiles for each defined cluster;
optionally attaching costs to each potential buy for each defined cluster; and
selecting one or more of the buys for the one or more media buyers.

2. The method of claim 1, further comprising:
optionally determining non-targeted individuals reached by each potential buy for each defined cluster; and
attaching costs to each potential buy based on information obtained from advertising sales individuals and/or companies.

3. The method of claim 1, further comprising obtaining an optimized rank-ordered list of each potential buy.

4. A computer readable tangible medium bearing executable computer code that causes a programmable device to carry out the method of claim 1.

5. An apparatus for carrying out the method of claim 1.

6. A method for optimizing advertising buying for one or media buyers having a budget for a multi-channel campaign but not a specified division of the budget for various channels in the campaign, comprising:
creating clusters based on media consumption habits of individuals;
creating media consumption profiles for each defined cluster;
optionally attaching costs to each potential buy for each defined cluster; and
selecting one or more of the buys for the one or more media buyers.

7. The method of claim 6, further comprising:
optionally determining non-targeted individuals reached by each potential buy for each defined cluster; and
attaching costs to each potential buy based on information obtained from advertising sales individuals and/or companies.

8. The method of claim 6, further comprising obtaining an optimized rank-ordered list of each potential buy.

9. A computer readable tangible medium bearing executable computer code that causes a programmable device to carry out the method of claim 6.

10. An apparatus for carrying out the method of claim 6.

11. A method for creating defined clusters for one or more media buyers seeking to buy advertising, comprising:
obtaining data on media consumption habits of a defined set of individuals;
optionally matching the data on media consumption habits to a database containing information regarding the individuals;
optionally recoding the data on media consumption using predetermined criteria to obtain recoded data;
optionally removing the data on media consumption to obtain the recoded data only; and
creating clusters based on media consumption habits of the individuals.

12. The method of claim 11, further comprising:
optionally determining non-targeted individuals reached by each potential buy for each defined cluster; and
attaching costs to each potential buy based on information obtained from advertising sales individuals and/or companies.

13. The method of claim 11, further comprising obtaining an optimized rank-ordered list of each potential buy.

14. A computer readable tangible medium bearing executable computer code that causes a programmable device to carry out the method of claim 11.

15. An apparatus for carrying out the method of claim 11.

16. A method for obtaining a cluster solution comprising:
(A) loading database A2 into a computer program, wherein database A2 is obtained by: obtaining data on media consumption habits of a defined set of individuals; matching the data on media consumption habits to a database containing information regarding the individuals; recoding the data on media consumption using predetermined criteria to obtain recoded data; optionally removing the data on media consumption to obtain the recoded data only, identified as database A2;
(B) selecting either manually or automatically the (i) optimal distance function, (ii) the clustering approach; (iii) the optimal agglomeration method, (iv) the minimum cluster size, (v) the method for pruning smaller clusters, and (vi) the sensitivity level;
(C) running the clustering program based on the selections in (B)(i)-(B)(v) to obtain a diagnostic output of clusters;
(D) examining the diagnostic output of clusters;
(E) repeating steps (B)-(D) until a cluster solution is obtained meeting the pre-determined criteria; and
(F) optionally validating the cluster solution.

17. The method of claim 16, further comprising:
(G) reviewing the cluster solution for logical consistency, optionally using a rules-based system, wherein any cluster solution which appears to have more than about 10% of clusters that are not logically consistent is flagged for review.

18. The method of claim 16, wherein the predetermined criteria include:
(a) the ratio of the distance between clusters relative to the distance within clusters is maximized, according to the distance function selection in (B)(i);
(b) the silwidth is larger than other potential cluster solutions; and
(c) the clusters are of a size and proportion useful to the one or more media buyers' goal.

19. The method of claim 16, wherein validating of cluster solution in step (F) comprises:
(a) adjusting the minimum cluster size and re-clustering to determine if the cluster solution is about the same; or
(b) bootstrappping the data and re-clustering to determine if the cluster solution is about the same.

20. A computer readable tangible medium bearing executable computer code that causes a programmable device to carry out the method of claim 16.

21. An apparatus for carrying out the method of claim 16.

22. A computer readable medium storing a computer program, the computer program when executed in a computer executing a method comprising:
(A) selecting either manually or automatically the (i) optimal distance function, (ii) the clustering approach; (iii) the optimal agglomeration method, (iv) the minimum cluster size, (v) the method for pruning smaller clusters, and (vi) the sensitivity level;
(B) running the clustering program based on the selections in (A)(i)-(A)(vi) to obtain a diagnostic output of clusters and outliers;
(C) examining the diagnostic output of clusters and outliers;
(D) repeating steps (A)-(C) until a cluster solution is obtained meeting the pre-determined criteria; and
(E) optionally validating the cluster solution.

23. The computer readable medium storing the computer program of claim 22, the method further comprising:
(F) reviewing the cluster solution for logical consistency, optionally using a rules-based system, wherein any cluster solution which appears to have more than about 10% of clusters that are not logically consistent is flagged for review.

24. The computer readable medium storing the computer program of claim 22, wherein the predetermined criteria include:
(a) the ratio of the distance between clusters relative to the distance within clusters is maximized, according to the distance function selection in (B)(i);
(b) the silwidth is larger than other potential cluster solutions;
(c) the clusters are of a size and proportion useful to the one or more media buyers' goal; and
(d) the size of the outliers is acceptable to the one or more media buyers.

25. The computer readable medium storing the computer program of claim 22, wherein validating of cluster solution in step (E) comprises:
(a) adjusting the minimum cluster size or re-clustering to determine if the cluster solution is about the same; or
(b) bootstrappping the data and re-clustering to determine if the cluster solution is about the same.

26. A method for optimizing advertising buying, comprising:
(i) obtaining data on media consumption habits of a defined set of individuals;
(ii) optionally matching the data on media consumption habits to a database containing information regarding the individuals;
(iii) optionally aggregating the data on media consumption habits by each individual;
(iv) optionally recoding the data on media consumption habits using predetermined criteria to obtain recoded data;
(v) optionally removing the data on media consumption habits to obtain the recoded data only;
(vi) creating clusters based on media consumption habits of the individuals;
(vii) optionally creating profiles of each cluster to obtain defined clusters;
(viii) optionally identifying the defined clusters;
(ix) creating media consumption profiles for each defined cluster;
(x) optionally determining non-targeted individuals reached by each potential buy for each defined cluster;
(xi) optionally attaching costs to each potential buy for each defined cluster;
(xii) defining buys based on maximum coverage of the targeted individuals, optionally minimum coverage of non-targeted individuals, and optionally the lowest cost; and
(xiii) obtaining an optimized rank-ordered list of buys for one or more one or more media buyers.

27. A computer readable tangible medium bearing executable computer code that causes a programmable device to carry out the method of claim 26.

28. An apparatus for carrying out the method of claim 26.

29. The method of claim 26, wherein in step (i) the data is individual-level, household-level, or smallest unit of measure.

30. The method of claim 29, wherein the smallest unit of measure data includes media consumption habits at a national level, state level, county level, neighborhood level, part of a neighborhood level, zip code level, precinct level, congressional district level, state house district level, state senate district level, regional level, individual level, household level, family level, media market level, cable system level, radio market level, and satellite television market level.

31. The method of claim 26, wherein in step (ii) the information regarding the individuals includes one or a combination of: demographic information, information about the neighborhood in which the individual lives, home ownership, employment status, location, party registration, microtargeting scores or models, models of other attributes or behaviors, vote history, purchase history, government licenses including licenses issued for certain recreations or occupations, geographic, consumer, attitudinal, behavioral data, other data of public record, or data that can be purchased, traded, or otherwise acquired.

32. The method of claim 26, wherein in step (iii) aggregating by individual, household, or smallest unit of measure.

33. The method of claim 26, wherein in step (iv) recoding of data is conducted to summarize the data based on (1) the size of the one or more media buyers' budget, (2) the level of detail about viewing habits available in the data, and (3) the number of cases in the data.

34. The method of claim 26, wherein in step (v) the original media consumption data is removed leaving the recoded data.

35. The method of claim 26, wherein in step (vi) the clustering is conducted by the method comprising:
(A) loading database A2 into a computer program, wherein database A2 is obtained by: obtaining data on media consumption habits of a defined set of individuals; matching the data on media consumption habits to a database containing information regarding the individuals; recoding the data on media consumption using predetermined criteria to obtain recoded data; optionally removing the data on media consumption to obtain the recoded data only identified as database A2;
(B) selecting either manually or automatically the (i) optimal distance function, (ii) the clustering approach; (iii) the optimal agglomeration method, (iv) the minimum cluster size, (v) the method for pruning smaller clusters, and (vi) the sensitivity level;
(C) running the clustering program based on the selections in (B)(i)-(B)(v) to obtain a diagnostic output of clusters;
(D) examining the diagnostic output of clusters;
(E) repeating steps (B)-(D) until a cluster solution is obtained meeting the pre-determined criteria; and
(F) optionally validating the cluster solution.

36. The method of claim 35, further comprising:
(G) reviewing the cluster solution for logical consistency, optionally using a rules-based system, wherein any cluster solution which appears to have more than about 10% of clusters that are not logically consistent is flagged for review.

37. The method of claim 35, wherein the predetermined criteria include:
(a) the ratio of the distance between clusters relative to the distance within clusters is maximized, according to the distance function selection in (B)(i);
(b) the silwidth is larger than other potential cluster solutions; and
(c) the clusters are of a size and proportion useful to the one or more media buyers' goal.

38. The method of claim 35, wherein validating of cluster solution in step (F) comprises:
(a) adjusting the minimum cluster size and re-clustering to determine if the cluster solution is about the same; or
(b) bootstrappping the data and re-clustering to determine if the cluster solution is about the same.

39. The method of claim 26, wherein in step (vii) creating profiles of each cluster to obtain defined clusters comprises: running one or more of a descriptive statistical algorithm; and summarizing characteristics of each cluster to obtained defined clusters.

40. The method of claim 26, wherein the media is one or a combination of television, radio, billboards, street furniture components, printed flyers and rack cards, cinema advertising, web banners, mobile telephone screens, shopping carts, web popups, skywriting, bus stop benches, magazines, newspapers, town criers, sides of buses or airplanes, in-flight advertisements, taxicabs, musical stage shows, subway platforms and trains, shopping cart handles, the opening section of streaming audio and video, posters, wall paintings, internet banner advertising, and the backs of event tickets and supermarket receipts.

41. The method of claim 26, wherein in step (viii) identifying the defined clusters comprises: targeting defined clusters with a high proportion of targeted individuals relative to non-targeted individuals.

42. The method of claim 26, wherein in step (ix) creating media consumption profiles for each defined cluster comprises: (i) determining which media channels were consumed; (ii) optionally determining the amount of media consumed in each channel;
and (iii) optionally generating a list of potential buys for each defined cluster.

43. The method of claim 26, wherein in step (x) determining non-targeted individuals reached by each potential buy for each defined cluster comprises: analyzing data on media consumption habits of the individuals in both targeted and non-targeted clusters to determine the number of each targeted and non-targeted individuals reached by each potential buy.

44. The method of claim 26, wherein in step (xi) attaching costs to each potential buy based on information obtained from advertising sales individuals and/or companies.

45. The method of claim 26, wherein in step (xii) defining buys based on maximum coverage of the targeted individuals, minimum coverage of non-targeted individuals, and the lowest cost comprises: reviewing the buys either manually or by using an optimization program.

46. The method of claim 26, wherein in step (xiii) obtaining an optimized rank-ordered list of buys for one or more media buyers comprises: rank-ordering the list based on one or more of steps (i)-(xii).

47. A computer readable tangible medium bearing executable computer code that causes a programmable device to carry out the method of claim 26.

48. An apparatus for carrying out the method of claim 26.

49. A method for creating clusters based on media consumption habits of individuals comprising:
obtaining data on media consumption habits of the individuals;
optionally aggregating the data on media consumption habits by each individual;
optionally recoding the data on media consumption habits using predetermined criteria to obtain recoded data; and
creating clusters based on media consumption habits of the individuals.

50. A computer readable tangible medium bearing executable computer code that causes a programmable device to carry out the method of claim 49.

51. An apparatus for carrying out the method of claim 49.

52. A method for creating clusters based on media consumption habits of individuals comprising:
obtaining data on media consumption habits of the individuals;
optionally matching the data on media consumption habits to a database containing information regarding the individuals;
optionally aggregating the data on media consumption habits by each individual;
optionally recoding the data on media consumption habits using predetermined criteria to obtain recoded data; and
creating clusters based on media consumption habits of the individuals.

53. A computer readable tangible medium bearing executable computer code that causes a programmable device to carry out the method of claim 52.

54. An apparatus for carrying out the method of claim 52.

55. A method for optimizing advertising buying, comprising:
(i) obtaining data on media consumption habits of a defined set of individuals;
(ii) matching the data on media consumption habits to a database containing information regarding the individuals;
(iii) aggregating the data on media consumption habits by each individual;
(iv) recoding the data on media consumption habits using predetermined criteria to obtain recoded data;
(v) removing the data on media consumption habits to obtain the recoded data only;
(vi) creating clusters based on media consumption habits of the individuals;
(vii) creating profiles of each cluster to obtain defined clusters;
(viii) identifying the defined clusters;
(ix) creating media consumption profiles for each defined cluster;
(x) determining non-targeted individuals reached by each potential buy for each defined cluster;
(xi) attaching costs to each potential buy for each defined cluster;
(xii) defining buys based on maximum coverage of the targeted individuals, minimum coverage of non-targeted individuals, and the lowest cost; and
(xiii) obtaining an optimized rank-ordered list of buys for one or more media buyers.

56. A computer readable tangible medium bearing executable computer code that causes a programmable device to carry out the method of claim 55.

57. An apparatus for carrying out the method of claim 55.

58. The method of claim 55, wherein in step (i) the data is individual-level, household-level, or smallest unit of measure.

59. The method of claim 58, wherein the smallest unit of measure data includes media consumption habits at a national level, state level, county level, neighborhood level, part of a neighborhood level, zip code level, precinct level, congressional district level, state house district level, state senate district level, regional level, individual level, household level, family level, media market level, cable system level, radio market level, and satellite television market level.

60. The method of claim 55, wherein in step (ii) the information regarding the individuals includes one or a combination of: demographic information, information about the neighborhood in which the individual lives, home ownership, employment status, location, party registration, microtargeting scores or models, models of other attributes or behaviors, vote history, purchase history, government licenses including licenses issued for certain recreations or occupations, geographic, consumer, attitudinal, behavioral data, other data of public record, or data that can be purchased, traded, or otherwise acquired.

61. The method of claim 55, wherein in step (iii) aggregating by individual, household, or smallest unit of measure.

62. The method of claim 55, wherein in step (iv) recoding of data is conducted to summarize the data based on (1) the size of the one or more media buyers' budget, (2) the level of detail about viewing habits available in the data, and (3) the number of cases in the data.

63. The method of claim 55, wherein in step (v) the original media consumption data is removed leaving the recoded data.

64. The method of claim 55, wherein in step (vi) the clustering is conducted by the method comprising:
(A) loading database A2 into a computer program, wherein database A2 is obtained by: obtaining data on media consumption habits of a defined set of individuals; matching the data on media consumption habits to a database containing information regarding the individuals; recoding the data on media consumption using predetermined criteria to obtain recoded data; optionally removing the data on media consumption to obtain the recoded data only identified as database A2;
(B) selecting either manually or automatically the (i) optimal distance function, (ii) the clustering approach; (iii) the optimal agglomeration method, (iv) the minimum cluster size, (v) the method for pruning smaller clusters, and (vi) the sensitivity level;
(C) running the clustering program based on the selections in (B)(i)-(B)(v) to obtain a diagnostic output of clusters;
(D) examining the diagnostic output of clusters;
(E) repeating steps (B)-(D) until a cluster solution is obtained meeting the pre-determined criteria; and
(F) optionally validating the cluster solution.

65. The method of claim 64 further comprising:
(G) reviewing the cluster solution for logical consistency, optionally using a rules-based system, wherein any cluster solution which appears to have more than about 10% of clusters that are not logically consistent is flagged for review.

66. The method of claim 64, wherein the predetermined criteria include:
(a) the ratio of the distance between clusters relative to the distance within clusters is maximized, according to the distance function selection in (B)(i);
(b) the silwidth is larger than other potential cluster solutions; and
(c) the clusters are of a size and proportion useful to the one or more media buyers' goal.

67. The method of claim 64, wherein validating of cluster solution in step (F) comprises:
(a) adjusting the minimum cluster size and re-clustering to determine if the cluster solution is about the same; or
(b) bootstrappping the data and re-clustering to determine if the cluster solution is about the same.

68. The method of claim 55, wherein in step (vii) creating profiles of each cluster to obtain defined clusters comprises: running one or more of a descriptive statistical algorithm; and summarizing characteristics of each cluster to obtained defined clusters.

69. The method of claim 55, wherein in step (viii) identifying the defined clusters comprises: targeting defined clusters with a high proportion of targeted individuals relative to non-targeted individuals.

70. The method of claim 55, wherein in step (ix) creating media consumption profiles for each defined cluster comprises: (i) determining which media channels were consumed; (ii) optionally determining the amount of media consumed in each channel; and (iii) optionally generating a list of potential buys for each defined cluster.

71. The method of claim 70, wherein in step (x) determining non-targeted individuals reached by each potential buy for each defined cluster comprises: analyzing data on media consumption habits of the individuals in both targeted and non-targeted clusters to determine the number of each targeted and non-targeted individuals reached by each potential buy.

72. The method of claim 55, wherein in step (xi) attaching costs to each potential buy based on information obtained from advertising sales individuals and/or companies.

73. The method of claim 55, wherein in step (xii) defining buys based on maximum coverage of the targeted individuals, minimum coverage of non-targeted individuals, and the lowest cost comprises: reviewing the buys either manually or by using an optimization program.

74. The method of claim 55, wherein in step (xiii) obtaining an optimized rank-ordered list of buys for one or more media buyers comprises: rank-ordering the list based on the one or more media buyers' goals.

75. The method of claim 55, wherein the media is one or a combination of television, radio, billboards, street furniture components, printed flyers and rack cards, cinema advertising, web banners, mobile telephone screens, shopping carts, web popups, skywriting, bus stop benches, magazines, newspapers, town criers, sides of buses or airplanes, in-flight advertisements, taxicabs, musical stage shows, subway platforms and trains, shopping cart handles, the opening section of streaming audio and video, posters, wall paintings, internet banner advertising, and the backs of event tickets and supermarket receipts.

76. The in-flight advertisements in claim 75 comprise advertising on seatback tray tables, overhead storage bins, seat backs, window shades, tray tables, and/or drink carts.

77. The taxicab advertisements in claim 75 comprise doors, roof mounts, and/or passenger screens.
